(19) United States
(12) Patent Application Publication
(10) Pub. No.: US 2003/0200071 A1
(43) Pub. Date: Oct. 23, 2003

(54) Simulation method

(75) Inventors: Hongyong Zhang, Kawasaki (JP); Hirokazu Miwa, Kawasaki (JP); Masahiro Kimura, Kawasaki (JP)

Correspondence Address: GREER, BURNS & CRAIN, 300 S WACKER DR, 25TH FLOOR, CHICAGO, IL, 60606, US

(73) Assignee: FUJITSU DISPLAY TECHNOLOGIES CORPORATION

(21) Appl. No.: 10/386,156

(22) Filed: Mar. 11, 2003

(30) Foreign Application Priority Data
Mar. 11, 2002 (JP) 2002-064844

(51) Int. Cl. G06F 17/50

(52) U.S. Cl. 703/15

(57) ABSTRACT

A simulation method is provided in which by using a device model of a thin film transistor in which a nonlinear resistance element or a transistor having characteristics different from an intrinsic transistor is connected to the intrinsic transistor without characteristic deterioration due to a hot carrier, and a circuit operation after hot carrier deterioration can be simulated even by a general-purpose circuit simulator. The nonlinear resistance element is connected to a drain electrode of the intrinsic transistor (conventional device model) without hot carrier deterioration, and an increase of nonlinear resistance due to hot carrier injection is simulated by the nonlinear resistance element. As the nonlinear resistance element, a transistor in which a drain and a gate are connected is used. An increase of channel resistance due to hot carrier deterioration is set by setting the channel length, channel width, and threshold value of the transistor to predetermined values.

### BACKGROUND OF THE INVENTION

1. Field of the Invention

The present invention relates to a simulation method of a thin film transistor (TFT), an electronic circuit using it, an integrated circuit and the like, and particularly to a simulation method in which a circuit operation after characteristic deterioration due to a hot carrier (hereinafter referred to as hot carrier deterioration) can be simulated even by a general-purpose circuit simulator.

2. Description of the Related Art

A low temperature crystallizing technique is indispensable for manufacture of a low temperature p-Si TFT (low temperature polysilicon thin film transistor) liquid crystal display device having a built-in peripheral circuit (hereinafter referred to as a peripheral circuit integrated liquid crystal display device). A typical low temperature crystallizing technique put to practical use at present is a low temperature crystallizing method using an excimer laser. By using the excimer laser, an excellent Si crystal thin film is formed on low-melting glass.

Next, a basic formation method of excimer laser crystallization will be described. An a-Si (amorphous silicon) starting thin film is formed on a glass substrate by using a thin film formation method such as PECVD (plasma enhanced chemical vapor deposition method using plasma). In order to improve the laser resistance of the starting film, hydrogen in the a-Si thin film is removed by a heat treatment of 400 to 450° C. The a-Si thin film is irradiated with a light beam of an excimer laser to be crystallized. The formed polysilicon thin film is treated in an atmosphere of hydrogen, water vapor or the like, so that the crystallinity is improved.

In the peripheral circuit integrated liquid crystal display device, by using the polysilicon semiconductor thin film, a switching TFT array is formed on a pixel display part, and a semiconductor integrated circuit is formed on a peripheral circuit part. The peripheral circuit part includes a gate bus line driving circuit, a data bus line driving circuit, and the like. In general, the data bus line driving circuit is constituted by using a high performance TFT having an operation frequency of a range of several MHz to several tens MHz, an electron field-effect mobility of 50 to 300 cm²/Vs and a suitable threshold voltage Vth. In the gate bus line driving circuit and the pixel display part, a request for the electron field-effect mobility is not so severe, and it is sufficient if the mobility is, for example, 20 cm²/Vs or higher.

Next, a new technical trend of a liquid crystal display device will be described. First, an effort toward an ultra high definition panel will be described. By the advance of multimedia and mobile technology, or the spread of the Internet, it usually becomes necessary to browse and process a large amount of information. Thus, a specification request for an ultra high definition display function becomes high to a liquid crystal display device as a man-machine interface. For example, in an application filed of a multi-screen display of a homepage of the Internet, a multitask processing, CAD design, or the like, a large high definition display device having a resolution of 200 dpi or more is required, and a small high definition liquid crystal display device is required for mobile use.

Next, a high performance peripheral circuit integrated large scale semiconductor circuit will be described. A technical trend has appeared in which an intelligent panel or a sheet computer is realized by providing a high performance large semiconductor integrated circuit on a peripheral circuit part in a low temperature polysilicon integrated panel. For example, a digital driver, a data processing circuit, a memory array, an interface circuit, and a CPU may also be incorporated in a liquid crystal panel.

Next, modeling of a p-Si TFT and a circuit simulation will be described. A structure of a circuit simulator SPICE popular in a semiconductor field is shown in FIG. 25. The SPICE is an acronym from Simulation Program with Integrated Circuit Emphasis, and is a circuit analysis program developed in the University of California, Berkeley (UCB).

A circuit diagram editor Schematics is a program for preparing a circuit diagram as a base of simulation. The simulator SPICE is a simulator main body and is a program in which circuit data (netlist), data (model parameter) of parts (devices etc.), or simulation commands are inputted in an ASCII file, and a simulation is performed. A waveform display Probe is a program for displaying a simulation result in a graph.

In general, a circuit simulation is performed in the following flow. (1) The circuit diagram editor Schematics designs a circuit (draw a circuit diagram). (2) The simulation setting Schematics sets the contents of the simulation, and parameters of a device model. (3) The simulator SPICE performs the simulation. (4) The waveform display Probe displays the result in a graph. (5) In case the result is different from a plan, the flow returns to (1) and circuit design is again performed.

A p-Si TFT is an electric-field transistor using a semiconductor thin film active layer, and is a member of a MOS transistor family. However, as compared with a MOS transistor using single crystal Si, the p-Si TFT uses polycrystalline thin film Si having a crystal grain boundary, and the thin film transistor has a specific structure, and therefore, a device model of a single crystal semiconductor MOS transistor used for the conventional SPICE can not be applied to the p-Si TFT.

Then, a device model of the p-Si TFT applicable to the SPICE simulator has been developed. For example, in a simulator SmartSpice developed by SILVACO Inc. of USA, plural TFT models (a-Si of RPI, poly-Si model, Leroux a-Si model, Berkeley poly-Si model) are prepared.

However, when a circuit simulation is performed using the above p-Si TFT model, there occurs a case where adequate consistency with actually measured data is not obtained. The following two reasons are conceivable for that. (1) There is a difference between a device structure of the model and an actual device structure. This problem can be solved to a certain degree by using a high-degree parameter extraction tool to carefully extract the device parameters from actual measurement, and by causing them to be reflected in the model. (2) By hot carrier (mainly hot electron) deterioration of an N-type TFT, an actual characteristic of the TFT deviates from an ideal value indicated by the model. This problem can not be solved by merely improving the accuracy of parameter extraction.

Hereinafter, the hot carrier deterioration of the p-Si TFT will be described. FIG. 26 is a view for explaining a device structure of a low temperature polysilicon thin film transistor (p-Si TFT). In a low temperature polysilicon thin film transistor (p-Si TFT) 100, a p-Si thin film 105 including a channel region 102, a lightly doped n⁻ (LDD) region 103, and a heavily doped (HDD) n⁺ region 104 is formed on an insulating substrate 101. A gate insulating film 106 is formed on the p-Si thin film 105. A gate electrode 107 is formed on the gate insulating film 106. An interlayer insulating film 108 is formed on the gate electrode 107. A source electrode 109 and a drain electrode 110 are formed on the interlayer insulating film 108. The source electrode 109 and the drain electrode 110 are respectively ohmic-contacted with the respective N⁺ semiconductor films (n⁺ regions) 104, 104 through contact holes 111, 111.

When the thin film transistor 100 operates, a depletion layer 112 in which electric field strength is high is formed in the vicinity of the drain. Thus, electrons passing through the depletion layer 112 are accelerated and become charged particles (hot carriers) having high energy, and partial hot carriers are injected into the gate insulating film 106, are captured in trap levels, and become captured electrons 113.

FIG. 27 is an energy band diagram of a MOS structure for explaining a carrier injection and a trap phenomenon. The band structure of the MOS structure includes a metal having Efm (Fermi level of metal), an insulating film (film thickness of Tox) having a large energy gap, and a semiconductor having a Fermi level Ef, a conduction band Ec, and a valence band Ev. An electron injection from the semiconductor side into the insulating film is roughly divided into a tunnel injection and a high energy injection (hot carrier injection). The tunnel injection occurs in the case where the electric field applied to the insulating film is very high. The high energy injection occurs in the vicinity of the drain depletion layer in which the horizontal electric field (direction of the flow of current) is high as described before. An electron entering the insulating film by the tunnel injection or the high energy injection is captured by the trap level at a definite probability, and becomes a fixed charge of the gate insulating film.

Hereinafter, a problem of hot carrier deterioration of the low temperature p-Si TFT transistor will be described.

(1) An operation voltage of a thin film transistor used for a peripheral circuit (a gate driver and a data driver) of the p-Si TFT liquid crystal panel is considerably high. This is because when DC (direct current) voltage is applied to a liquid crystal cell, a liquid crystal material is deteriorated, so that an AC driving method of liquid crystal is adopted. That is, display signals of positive polarity and negative polarity are alternately applied to the liquid crystal cell. Thus, the amplitude of the display signal becomes twice as high as the liquid crystal driving voltage. For example, in the case of a liquid crystal display device in which a liquid crystal driving voltage range from a black display to a white display is 5 V (volt), the amplitude of the display signal becomes 10 V.

Further, in the case of an active matrix driving system, a pixel TFT is connected in series to a liquid crystal cell, a display signal (voltage) is written in the liquid crystal cell in an ON state of the pixel TFT, and the written display signal (voltage) is held in an off state of the pixel TFT. In order to certainly put the pixel TFT in the on/off state, it is necessary to take an operation voltage margin called an on voltage margin and an off voltage margin. In general, the on voltage margin is 3 to 4 V, and the off voltage margin is 2 to 3 V. Thus, it is necessary to add the on/off voltage margin to the amplitude voltage of the foregoing AC driving.

For example, in the case of the liquid crystal display device in which the liquid crystal driving voltage range is 5 V, the power supply voltage of the gate driver becomes 10 V (signal amplitude)+(3 to 4) V (on voltage margin)+(2 to 3) V (off voltage margin)=(15 to 17) V. Accordingly, the power supply voltage of the MOSFET of the peripheral circuit including the gate driver also becomes 15 to 17 V. As compared with a power supply voltage of 2.5 to 3.3 V of a semiconductor integrated circuit (LSI), the operation power supply voltage of the p-Si TFT becomes 5 to 6 times as high. When the power supply voltage becomes high, the electric field strength in the vicinity of the drain becomes high, and hot carrier injection becomes apt to occur.

(2) Crystallinity and surface flatness of p-Si are low. At present, an excimer laser (pulse laser) is used as a method of crystallizing a-Si into p-Si. Since the period of a light pulse is as short as 20 to 40 ns (nanosecond), the crystal grain diameter of p-Si is as small as 1 μm (micrometer) or less, and a large number of grain boundary defects exist. Thus, a carrier passing through the depletion layer is scattered by these grain boundary defects. Further, since crystal orientations of crystal grains are different from one another, surface roughness exists. By this, the trap level density of an interface between the p-Si layer and the gate insulating film is high. Thus, the electron field-effect mobility μ indicating the performance of the p-Si TFT is about 1/10 to ¼ of that of a single crystal MOSFET (600 to 800 cm²/Vs).

(3) Since a low temperature process is used, there are many defects in the gate oxide film (insulating film) due to the process. Since the gate insulating film of the p-Si TFT is formed by the PECVD method at 300 to 400° C., the trap level density in the film is higher than a thermal oxidation film of a MOSFET. Besides, since O₂+TEOS system, SiH₄+N₂O system or the like is used as a reaction gas, there is a lot of H₂O regarded as the cause of generation of neutral trap levels in the gate insulating film.

(4) An activation rate of LDD is low. In the ion doping process for forming the LDD region, an impurity ion (P⁺, PHₓ⁺, etc.) having high energy passes through the gate oxide film and is implanted into the p-Si layer to damage the oxide film. Thereafter, even if impurity activation is performed, a recover ratio of defects is low. Particularly, in the case of only laser activation, the activation ratio and the defect recovery ratio are low. Besides, at ion doping, a large number of H⁺ ions enter the oxide film, and become the cause of increase of H₂O in the film.

From the cause as described above, characteristic deterioration due to the hot carrier of the p-Si TFT becomes a problem which can not be neglected. At present, the hot carrier of the p-Si TFT must be considered at the time of circuit design, characteristic analysis, reliability evaluation, and lifetime prediction.

Next, a specific example of characteristic deterioration of a TFT element due to the hot carrier deterioration of the p-Si TFT will be described with reference to FIGS. 28A to 29B. FIGS. 28A and 28B are graphs showing deterioration examples of an ID-VG characteristic and a μ-VG characteristic due to the hot carrier injection. FIG. 28A shows a drain current-gate voltage characteristic (ID-VG characteristic) of a linear region of an n-channel TFT in the case where a drain voltage VD is fixed to 1 V (volt). FIG. 28B shows an electron field-effect mobility-gate voltage characteristic (μ-VG characteristic) of the n-channel TFT in the case where the drain voltage VD is fixed to 1 V (volt). In FIGS. 28A and 28B, the characteristic before stress is indicated by a solid line, and the characteristic after stress is indicated by a broken line.

When the voltage stress is applied to the n-channel TFT (when an accelerated test is carried out), as compared with the initial characteristic before the stress, after the stress, as shown in FIG. 28A, the on current is decreased by ΔIon, and as shown in FIG. 28B, the electron field-effect mobility is decreased by Δμ. Here, as a condition of the stress (accelerated test), there are a DC stress and an AC stress, and characteristic deterioration due to the DC stress is severer than the AC stress. The deterioration degrees of the on current Ion and the electron field-effect mobility μ vary by the stress condition, and when the stress is slight, the characteristic deterioration is several % with respect to the initial characteristic, and when the stress is heavy, the characteristic deterioration is several tens % with respect to the initial characteristic. Incidentally, although the off current Ioff is also deteriorated by the accelerated test, since a bad influence on use is slight, an argument will not be made here.

FIGS. 29A and 29B are graphs showing deterioration examples of an ID-VD characteristic and an RD-VD characteristic due to the hot carrier injection. FIG. 29A is a graph showing a drain current-drain voltage characteristic (ID-VD characteristic) of an n-channel TFT in the case where a gate voltage VG is fixed to 10V, and FIG. 29B is a graph showing an on resistance-drain voltage characteristic (RD-VD characteristic) of the n-channel TFT in the case where the gate voltage VG is fixed to 10 V. In FIGS. 29A and 29B, the characteristic before the stress is indicated by a solid line, and the characteristic after the stress is indicated by a broken line.

When the voltage stress (accelerated test) is applied to the n-channel TFT, as compared with the initial characteristic before the stress, after the stress, as shown in FIG. 29A, the on current Ion is decreased by ΔIon, and as shown in FIG. 29B, the on resistance RD is increased ΔRD. The degree of the hot carrier deterioration depends on the drain voltage VD, and the deterioration (the decrease ΔIon of the on current Ion, and the increase ΔRD of the on resistance RD) is serious in a linear region where the drain voltage VD is low, and the degree of the deterioration is low in a saturation region where the drain voltage VD is high. Here, as a feature of the ID-VD characteristic with the hot carrier deterioration, the drain current ID does not become saturated with respect to the increase of the drain voltage VD, and in order to make the drain current ID flow, the drain voltage VD not less than ΔVD must be applied. Here, ΔVD is called “deterioration offset voltage”.

FIGS. 30A to 30C are views showing a deterioration example of an output-input characteristic (Vo-Vin characteristic) of a CMOS inverter due to the hot carrier injection. FIG. 30A is an equivalent circuit diagram of a CMOS inverter, FIG. 30B is a simplified circuit diagram of the CMOS inverter, and FIG. 30C is a graph showing the output-input characteristic of the CMOS inverter. In FIG. 30B, a p-ch (p-channel) TFT is replaced by a variable resistance Rdp, and an n-ch (n-channel) TFT is replaced by a variable resistance Rdn.

When a voltage stress is applied to the CMOS inverter (accelerated test is carried out), as compared with the initial characteristic before the stress, after the stress, the output voltage Vo is raised on a low potential side (side of a logical level of 0, that is, Low side). For example, after the stress, the output voltage Vo is increased by about ΔVoL from 0.1 VDD. The cause of the increase of the output voltage Vo is the increase of the on resistance value Rdn due to the hot carrier deterioration. The output voltage Vo is determined by the resistance ratio of the p-channel (p-ch) TFT and the n-channel (n-ch) TFT. As shown in FIG. 30B, when the resistance value of the p-channel TFT is Rdp, and the resistance value of the n-channel TFT is Rdn, the output voltage is expressed by equation 1.

Vo=VDD{1/(1+Rdp/Rdn)} (1)

In the case where Rdp is a value sufficiently large with respect to Rdn, the output voltage Vo is approximated by VDD(Rdn/Rdp). From this equation, it is understood that in the case where the n-channel TFT is deteriorated, since the channel resistance Rdn is increased by the decrease of the on current, the output resistance ratio (Rdn/Rdp) becomes a large value, and the output voltage Vo is increased.

As described above, when the hot carrier is injected into the gate insulating film of the n-channel TFT, the on current Ion of the TFT is decreased, and the on resistance RD is increased. By this, the drive capability of the n-channel TFT is lowered, a signal delay time is prolonged, and a maximum operation frequency is lowered. Besides, in the case of the CMOS inverter, the “LOW” output level is raised, so that a voltage insurance margin of a logic operation becomes small, and an erroneous operation occurs.

On the other hand, since various characteristics of the low temperature polysilicon n-channel TFT having hot carrier deterioration deviate from the characteristics of an ideal device model of a simulation tool (SPICE etc.), it is difficult to accurately analyze (simulate) the circuit operation by using the device model of the simulation tool.

Various techniques for performing various simulations in view of the characteristic deterioration due to the hot carrier as described above have been proposed as described below.

JP-A-7-99302 discloses a method in which the stress dependence of an index n in an equation for predicting a hot carrier deterioration rate of a MOS transistor is obtained, so that the hot carrier deterioration is simulated with high accuracy under not only DC stress but also AC stress.

JP-A-9-186213 discloses a parameter extraction method of characteristic deterioration in a semiconductor device, for extracting a damage distribution in a MOSFET due to a hot carrier. In this parameter extraction method, data concerning the structure of a virtual device are inputted as initial values, and data of a damage distribution in the device are inputted as additional initial values, and electric characteristics of the virtual device after deterioration calculated by the predetermined device simulator is compared with electric characteristics of an actual device, which is prepared to be equivalent to the structure of the above device, measured after the predetermined stress state is applied. In the case where the comparison result indicates inconsistency, the additional initial value is changed, and the electric characteristic of the virtual device after the deterioration is recalculated by the device simulator. In the case where the electric characteristics of both are almost coincident with each other, the damage distribution of the additional initial value is extracted as a parameter of the characteristic deterioration, and the additional initial value is changed until both are coincident with each other, and the process of the device simulation is iterated.

JP-A-11-97501 discloses a reliability design method of a semiconductor integrated circuit in which the number of times that trial and error are repeated is small and reliability design of a circuit is efficiently enabled, and a delay time deterioration amount not higher than a predetermined reference can be achieved without a drop in integration density of a semiconductor integrated circuit or a drop in operation speed. This reliability design method includes a first step of obtaining a delay time deterioration amount of the semiconductor integrated circuit by simulation, a second step of comparing the delay time deterioration amount obtained by this simulation with a predetermined reference value, a third step of, when the delay time deterioration amount exceeds the reference value, obtaining an individual delay time deterioration amount due to deterioration of each transistor by individually deteriorating respective transistors in the semiconductor integrated circuit by simulation, and a fourth step of taking hot carrier measures to a transistor having a large individual delay time deterioration amount. Until the delay time deterioration amount becomes the reference value or less as the result of the comparison at the second step, the third→the fourth→the→first the second step are sequentially iterated.

JP-A-11-97676 discloses a reliability simulation method of a semiconductor integrated circuit, which can simulate a circuit operation after deterioration also with respect to a circuit including a MOSFET to which bidirectional hot carrier stress is applied. In this reliability simulation method, the direction of the hot carrier stress is judged based on which terminal of a source or a drain has a high voltage at the time when a substrate current or a gate current is maximum with respect to the MOSFET. A simulation time is divided into periods when the MOSFET is in a forward direction or a backward direction, and in the respective period, reference is made to a SPICE parameter table of a post-deterioration forward direction or backward direction, to create a post-deterioration SPICE parameter, and a post-deterioration operation waveform is calculated using the post-deterioration SPICE parameter.

JP-A-2000-339356 discloses a method of simulating a hot carrier effect in an IC at a circuit level. In this simulation method, a hot carrier timing library containing delay data of each cell is created from data of IC cells. Scaled post-deterioration timing data is created by using this hot carrier timing library. Then, the operation of the IC is simulated using this post-deterioration timing data by a logic simulator or a timing analyzer. The post-deterioration timing data is created on the basis of the cell delay data and a switching frequency of each cell at each time.

JP-A-2000-340789 discloses a simulation method in which in a circuit including a MOS transistor to which bidirectional hot carrier stress is applied, an influence of deterioration of a threshold value on a circuit operation subsequent to the deterioration can be simulated with high accuracy. In circuit description data inputted to a circuit simulator for simulating drain current and threshold value current deterioration, a variable voltage source for outputting a voltage of threshold voltage deterioration ΔVth is added to a portion between a gate electrode of a MOS transistor before hot carrier deterioration and a connection point connected to the gate electrode, so that characteristics subsequent to the deterioration is simulated. The threshold voltage deterioration ΔVth subsequent to the bidirectional stress is expressed by the sum of a threshold voltage deterioration (ΔVth)D due to drain terminal deterioration of the MOS transistor and threshold voltage deterioration (ΔVth)S due to source terminal deterioration.

JP-A-2001-53273 discloses a reliability simulation method in which a model without a fitting error or a lifetime error due to hot carrier deterioration intrinsic to AC is prepared as a reliability simulation model. After an experiment by a substrate current model, a gate current model or the like and preparation of a model equation of simulation are carried out, a DC stress application experiment is carried out, and H and m as hot carrier lifetime parameters are corrected on the basis of the experimental data. By this processing, the fitting error of the model equation is cancelled. Next, a stress application experiment is performed to a ring oscillator to obtain a lifetime of the ring oscillator and a voltage acceleration coefficient, m and H are sequentially corrected in accordance with the voltage acceleration coefficient of the experimental data, and the model equation is corrected according to this correction. By this processing, the error of the model equation due to the hot carrier deterioration intrinsic to AC is cancelled. By this, high simulation accuracy can be obtained for a combinational logic circuit or the like fabricated by the same process.

JP-A-2001-284457 discloses a design method of a semiconductor device suitable for optimization relating to reliability of a logic product design in a cell unit by using delay library having parameters to calculate deterioration due to a hot carrier. A design system to which this design method of the semiconductor device is applied includes a detailed simulation part which requires a long time and a rapid simulation part of a whole product. Two new parameters Ac and n for hot carrier deterioration calculation (deterioration=Actn) are added to the delay library of the rapid simulation part of the whole product. Where, n denotes a gradient dependent on time, and depends on a circuit structure and a bias voltage received by a cell, and Ac depends on the circuit structure and the bias voltage received by the cell. By this, when optimization of the design is executed, it can be executed in the rapid simulation part of the whole product without crossing the detailed simulation part requiring a long time.

However, in the respective techniques disclosed in the respective publications, the dedicated systems or programs must be newly prepared to simulate the hot carrier deterioration. Then, it has been desired to perform a circuit simulation, a characteristic analysis, and a lifetime prediction in view of hot carrier deterioration by using an existing simulator, for example, SPICE.

### SUMMARY OF THE INVENTION

The present invention has been made to solve the problems as described above, and has an object to provide a simulation method in which a circuit simulation including a characteristic change due to a hot carrier can be carried out by using an existing general-purpose circuit simulator.

The above object can be achieved by a simulation method characterized by constructing a device model of a thin film transistor, which is formed on an insulating substrate, from an intrinsic transistor without hot carrier deterioration and a nonlinear resistance element connected in series to a drain electrode of the intrinsic transistor, and performing a circuit simulation using the device model of the thin film transistor.

### BRIEF DESCRIPTION OF THE DRAWINGS

FIGS. 1A to 1C are views showing a correction model of a thin film transistor using a simulation method according to an embodiment of the invention, in which FIG. 1A is a view showing a nonlinear resistance correction model, FIG. 1B is a view showing a diode correction model, and FIG. 1C is a view showing a multi-diode correction model;

FIGS. 2A and 2B are views showing the principle of the diode correction model according to the embodiment of the invention, in which FIG. 2A is a graph showing an IF-VF characteristic of a single crystal diode, and FIG. 2B is a graph showing an ID-VD characteristic of a thin film transistor corrected with a correction diode, a curved line A in FIG. 2A indicating a characteristic of a single diode having a threshold voltage VT, and a curved line B indicating a characteristic of a double diode having a threshold voltage 2 VT;

FIGS. 3A and 3B are views showing a diode connection transistor correction model according to the embodiment of the invention, in which FIG. 3A is a view showing a basic structure (nonlinear resistance correction model) of the diode connection transistor correction model, and FIG. 3B is a view showing a specific example of the diode connection transistor correction model;

FIGS. 4A and 4B are views showing the correction principle of a diode connection transistor correction model, in which FIG. 4A is a graph showing an ID-VD characteristic of a diode-connected transistor (correction transistor), and FIG. 4B is a graph showing an ID-VD characteristic of a corrected thin film transistor (transistor made up of an intrinsic transistor T and a correction transistor Th);

FIGS. 5A and 5B are views showing a compound correction model according to the embodiment of the invention, in which FIG. 5A is a view showing a single path compound correction model, and FIG. 5B is a view showing a multi-path compound correction model;

FIGS. 6A to 6C are equivalent circuit diagrams of a CMOS inverter using a device model (correction model) according to the embodiment of the invention, in which FIG. 6A is an equivalent circuit diagram using a diode correction model, FIG. 6B is an equivalent circuit diagram using a diode connection transistor correction model, and FIG. 6C is an equivalent circuit diagram using a compound correction model;

FIGS. 7A to 7C are equivalent circuit diagrams of a transfer gate (analog switch) using a device model (correction model) according to the embodiment of the invention, in which FIG. 7A is an equivalent circuit diagram using a diode correction model, FIG. 7B is an equivalent circuit diagram using a diode connection transistor correction model, and FIG. 7C is an equivalent circuit diagram using a compound correction model;

FIGS. 8A to 8C are views for explaining application to a simulation tool according to the embodiment of the invention;

FIGS. 9A and 9B are graphs showing an ID-VD characteristic of an n-channel TFT, in which FIG. 9A is a graph showing the characteristic before stress application, and FIG. 9B is a graph showing the characteristic after the stress application;

FIGS. 10A and 10B are graphs showing an ID-VD characteristic of a p-channel TFT, in which FIG. 10A is a graph showing the characteristic before stress application, and FIG. 10B is a graph showing the characteristic after the stress application;

FIGS. 11A and 11B are graphs showing an RD-VD characteristic of an n-channel TFT, in which FIG. 11A is a graph showing the characteristic before stress application, and FIG. 11B is a graph showing the characteristic after the stress application;

FIGS. 12A and 12B are graphs showing an RD-VD characteristic of a p-channel TFT, in which FIG. 12A is a graph showing the characteristic before stress application, and FIG. 12B is a graph showing the characteristic after the stress application;

FIGS. 13A and 13B are graphs showing an input/output characteristic of an initial stage output of a two-stage inverter and a differential characteristic of the initial stage output, in which FIG. 13A is a graph showing the input/output characteristic of the initial stage output, and FIG. 13B is a graph showing the differential characteristic of the initial stage output;

FIGS. 14A and 14B are graphs showing an input/output characteristic of a latter stage output of the two-stage inverter and a differential characteristic of the latter stage output, in which FIG. 14A is a graph showing the input/output characteristic of the latter stage output, and FIG. 14B is a graph showing the differential characteristic of the latter stage output;

FIG. 15 is a graph showing a simulation result of an ID-VD characteristic of an n-channel TFT model to which the diode correction model according to the embodiment of the invention is applied;

FIGS. 16A to 16C are graphs showing simulation results of an ID-VD characteristic of an n-channel TFT model to which the diode connection transistor correction model according to the embodiment of the invention is applied, in which FIG. 16A is a graph showing the simulation result in the case where a channel length Lh of a correction transistor Th is made 0.3 μm, FIG. 16B is a graph showing the simulation result in the case where the channel length Lh of the correction transistor Th is made 1 μm, and FIG. 16C a graph showing the simulation result in the case where the channel length Lh of the correction transistor Th is made 6 μm;

FIGS. 17A to 17C are graphs showing simulation results of the ID-VD characteristic of the n-channel TFT model to which the diode connection transistor correction model according to the embodiment of the invention is applied, in which FIG. 17A is a graph showing the respective simulation results of FIGS. 16A to 16C in one graph, FIG. 17B is a graph showing the channel length Lh dependence of the correction transistor Th of the ID-VD characteristic, and FIG. 17C is a graph showing current-voltage characteristics of the correction transistor Th;

FIG. 18 is a graph showing a simulation result of an input/output characteristic of an inverter model to which the diode connection transistor correction model according to the embodiment of the invention is applied;

FIGS. 19A to 19D are graphs showing simulation results of an oscillation frequency and an oscillation waveform on a ring oscillator (nine-stage inverter structure) constructed by using the inverter model to which the diode connection transistor correction model according to the embodiment of the invention is applied, in which FIG. 19A is a graph showing the simulation result in the case where an intrinsic transistor model without hot carrier deterioration is used, FIG. 19B is a graph showing the simulation result in the case where the correction transistor Th having a channel length of 0.3 μm is used, FIG. 19C is a graph showing the simulation result in the case where the correction transistor Th having a channel length of 1 μm is used, and FIG. 19D is a graph showing the simulation result in the case where the correction transistor Th having a channel length of 6 μm is used;

FIG. 20 is a graph showing a simulation result of an ID-VD characteristic of an n-channel TFT to which the compound correction model according to the embodiment of the invention is applied, and is a graph showing the simulation result in which the channel length of a correction transistor is fixed to 0.3 μm, and the channel width is made 5, 9, 9.5 and 10 μm;

FIG. 21 is a graph showing a simulation result of an ID-VD characteristic of an n-channel TFT to which the compound correction model according to the embodiment of the invention is applied, and is a graph showing the simulation result in which the channel length of the correction transistor is fixed to 5 μm, and the channel width is made 0.3, 3 and 6 μm;

FIG. 22 is a graph showing a simulation result of an AC (alternating current) characteristic of a two-stage cascade connection circuit of an inverter constructed using an n-channel TFT to which the compound correction model according to the embodiment of the invention is applied, and is a graph showing the simulation result in which the channel length Lh of the correction transistor is made 0.3 μm;

FIG. 23 is a graph showing a simulation result of an AC (alternating current) characteristic of a two-stage cascade connection circuit of an inverter constructed using an n-channel TFT to which the compound correction model according to the embodiment of the invention is applied, and is a graph showing the simulation result in which the channel length Lh of the correction transistor is made 1 μm;

FIG. 24 is a graph showing a simulation result of an AC (alternating current) characteristic of a two-stage cascade connection circuit of an inverter constructed using an n-channel TFT to which the compound correction model according to the embodiment of the invention is applied, and is a graph showing the simulation result in which the channel length Lh of the correction transistor is made 6 μm;

FIG. 25 is a structural view of the circuit simulator SPICE most popular in the semiconductor field;

FIG. 26 is a view for explaining a device structure of a low temperature polysilicon thin film transistor (p-Si TFT);

FIG. 27 is an energy band diagram of a MOS structure for explaining a carrier injection and a trap phenomenon;

FIGS. 28A and 28B are graphs showing deterioration examples of an ID-VG characteristic and μ-VG characteristic due to a hot carrier injection, in which FIG. 28A is a graph showing a drain current-gate voltage characteristic (ID-VG characteristic) in a linear region of an n-channel TFT in the case where a drain voltage VD is fixed to 1 V (volt), and FIG. 28B is a graph showing an electron field-effect mobility-gate voltage characteristic (μ-VG characteristic) of the n-channel TFT in the case where the drain voltage VD is fixed to 1 V (volt);

FIGS.. 29A and 29B are graphs showing deterioration examples of an ID-VG characteristic and an RD-VD characteristic due to a hot carrier injection, in which FIG. 29A is a graph showing a drain current-drain voltage characteristic (ID-VG characteristic) of an n-channel TFT in the case where a gate voltage VG is fixed to 10 V (volt), and FIG. 29B is a graph showing an on resistance-drain voltage characteristic (RD-VD characteristic) of the n-channel TFT in the case where the gate voltage VG is fixed to 10 V; and

FIGS. 30A to 30C are views showing deterioration examples of an output-input (Vo-Vin characteristic) of a CMOS inverter due to a hot carrier injection, in which FIG. 30A is an equivalent circuit diagram of the CMOS inverter, FIG. 30B is a simplified circuit diagram of the CMOS inverter, and FIG. 30C is a graph showing the output-input characteristic of the CMOS inverter.

### DETAILED DESCRIPTION OF THE PREFERRED EMBODIMENT

Before the explanation of embodiments of the present invention, the principle of the invention will be described. A simulation method of the invention is characterized in that a device model of a thin film transistor is used in which an element for correcting a characteristic change caused by hot carrier deterioration is coupled to a device model of an intrinsic thin film transistor without hot carrier deterioration, so that a circuit simulation including a characteristic change due to a hot carrier can be performed by using a general-purpose circuit simulator, for example, SPICE. Thus, the device model of the thin film transistor formed on an insulating substrate is made up of an intrinsic transistor without hot carrier deterioration and a nonlinear resistance element connected in series to a drain electrode of this intrinsic transistor. The feature is that the circuit simulation is performed using the device model of the thin film transistor made up of this intrinsic transistor and the nonlinear resistance element.

The nonlinear resistance element is connected to the drain electrode of the intrinsic transistor (conventional device model) without the hot carrier deterioration, and an increase of a nonlinear resistance by a hot carrier injection is simulated by this nonlinear resistance element, so that the thin film transistor can be more accurately modeled. By this, the circuit simulation including the characteristic change caused by the hot carrier can be performed.

Incidentally, a diode may be used as the nonlinear resistance element. By setting the number of diodes connected in series to the drain electrode of the intrinsic transistor, an increase of the channel resistance due to the hot carrier deterioration may be set.

Besides, a transistor in which a gate electrode and a drain electrode are short-circuited may be used as the nonlinear resistance element. By setting the channel length, channel width and threshold value of this transistor, an increase of the channel resistance due to the hot carrier deterioration may be set.

As another simulation method of the invention, a device model of a thin film transistor formed on an insulating substrate is made up of an intrinsic transistor without the hot carrier deterioration and a transistor connected in parallel with a source electrode and a drain electrode of this intrinsic transistor and having the hot carrier deterioration. The feature is that the circuit simulation is performed using the device model of the thin film transistor made up of this intrinsic transistor and the transistor having the hot carrier deterioration.

Incidentally, the transistor having the hot carrier deterioration may be constructed by combining plural transistors. By combining the plural transistors, the hot carrier deterioration characteristic may be simulated with high accuracy.

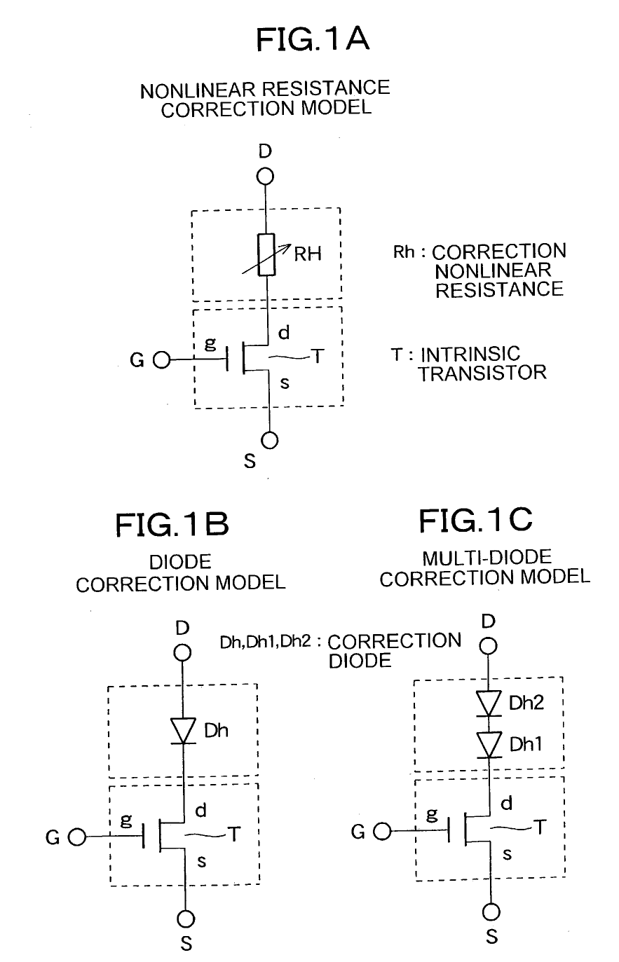

Next, a simulation method according to an embodiment of the invention will be described using FIGS. 1 to 24. FIGS. 1A to 1C are views showing correction models of a thin film transistor used for the simulation method according to this embodiment. FIG. 1A is a view showing a nonlinear resistance correction model, FIG. 1B is a view showing a diode correction model, and FIG. 1C is a view showing a multi-diode correction model.

FIG. 1A is for explaining the basic concept of the correction model, and in the nonlinear resistance correction model of the thin film transistor shown in FIG. 1A, a nonlinear resistance Rh is connected to a drain electrode of a model (conventional thin film transistor model) of an intrinsic transistor T including a source electrode s, a gate electrode g, and a drain electrode d. A channel resistance value increased by the hot carrier injection is expressed by this nonlinear resistance Rh. The nonlinear correction model of this thin film transistor includes three external terminals of a source electrode S, a gate electrode G and a drain electrode D.

In the diode correction model shown in FIG. 1B, a correction diode Dh as the nonlinear resistance is connected to a drain electrode d of an intrinsic transistor model T. A channel resistance value increased by the hot carrier injection is expressed by connecting the correction diode Dh to the drain electrode d. The resistance value of this correction diode Dh is changed depending on a drain voltage VD (that is, applied voltage on the element). Besides, the corrected transistor includes three external terminals of a source electrode S, a gate electrode G and a drain electrode D. In the multi-diode correction model shown in FIG. 1C, two correction diodes Dh1 and Dh2 are connected in series to a drain electrode d of an intrinsic transistor T.

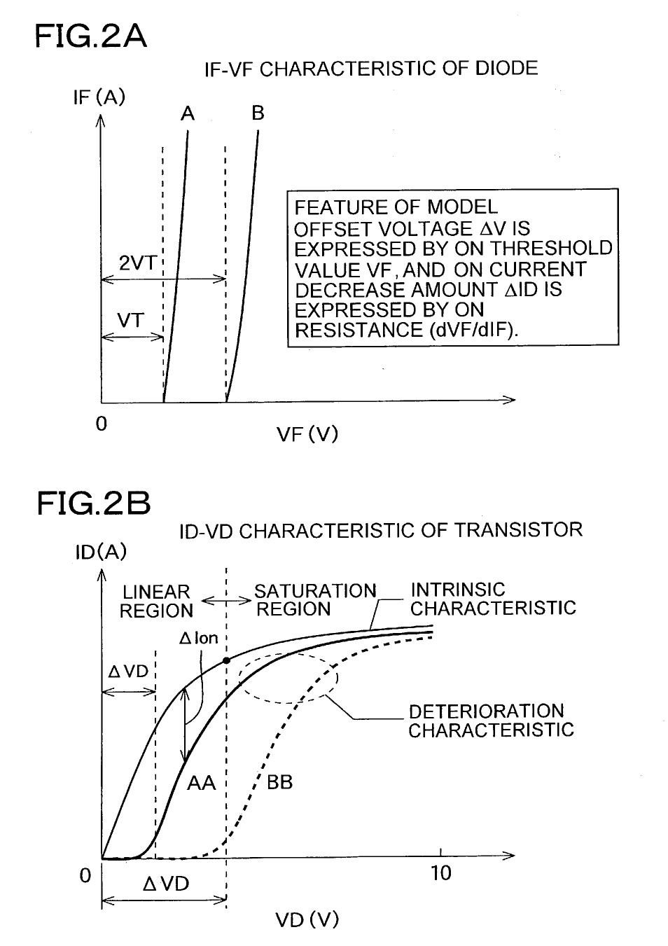

FIGS. 2A and 2B are views showing the principle of the diode correction model according to this embodiment. FIG. 2A is a graph showing an IF-VF characteristic of a single crystal diode, and FIG. 2B is a graph showing an ID-VD characteristic of a thin film transistor corrected by a correction diode. In FIG. 2A, a curved line A indicates a characteristic of a single diode having a threshold voltage VT, and a curved line B indicates a characteristic of a double diode having a threshold voltage 2 VT.

As shown in FIG. 2B, by the threshold voltage of the correction diode, an ID-VD curved line AA corrected by the single diode is shifted in a positive direction by about VT, and an ID-VD curved line BB corrected by the double diode is shifted in the positive direction by about 2 VT. Besides, a decrease amount ΔIon of an on current is larger in a linear region (the smaller VD is, the larger it is).

As stated above, in the case of the diode correction model, “offset voltage ΔVD” due to the hot carrier deterioration can be expressed by the threshold value VT of the diode. That is, the shift degree (ΔVD) of the ID-VD characteristic may be set by the number of correction diodes. Besides, a decrease ΔID of the on current due to the hot carrier deterioration can be expressed by the total on resistance of the diode (that is, a differential value of the IF-VF characteristic curved line). The resistance value of the correction diode can be easily adjusted by adjusting a dimension parameter of the correction diode and other structural/physical parameters.

Since a model of a thin film transistor does not exist in a commercially available simulation tool, the single crystal diode model is used. Accordingly, in the case where the diode correction model shown in FIGS. 1A and 1B is used, it is necessary that a deterioration characteristic of a TFT is actually measured by a stress test to perform fitting to the model.

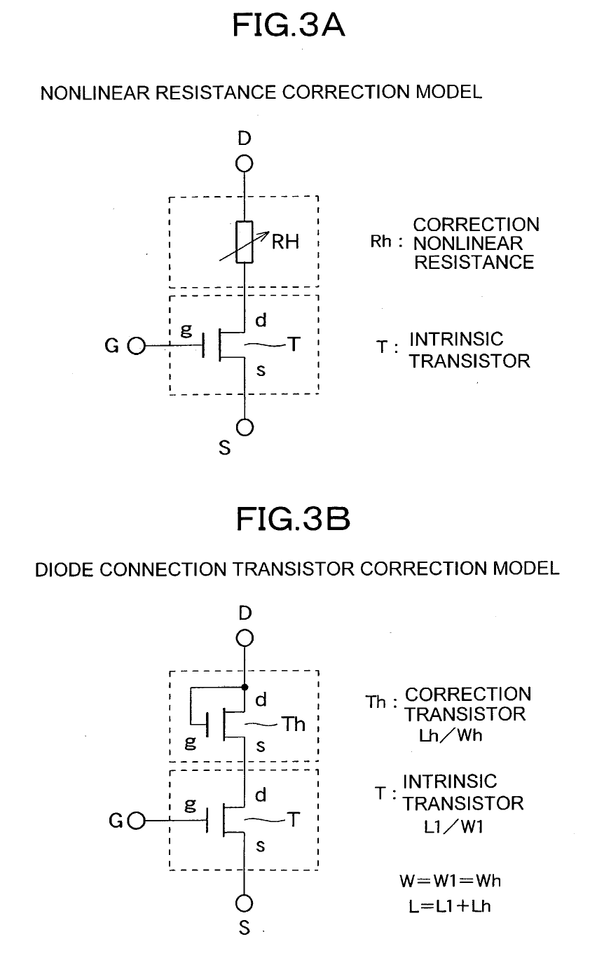

FIGS. 3A and 3B are views showing a diode connection transistor correction model according to this embodiment. FIG. 3A is a view showing the basic structure of the diode connection transistor correction model (nonlinear resistance correction model), and FIG. 3B is a view showing a specific example of the diode connection transistor correction model.

As shown in FIG. 3B, a correction transistor Th in which a gate electrode g and a drain electrode d are short-circuited is connected as a nonlinear resistance Rh to a drain electrode d of an intrinsic transistor T including a source electrode s, a gate electrode g and the drain electrode d, so that a channel resistance value (nonlinear resistance) increased by the hot carrier injection is expressed. A nonlinear resistance value of this correction transistor Th is changed depending on an external drain voltage VD (that is, an applied voltage Vds between the source s and the drain d of the correction transistor Th). The correction model (corrected transistor) made up of the intrinsic transistor T and the correction transistor Th includes three external terminals of a source electrode S, a gate electrode G and a drain electrode D. Here, it is assumed that a channel width W1 of the intrinsic transistor T and a channel width Wh of the correction transistor Th are identical to each other (W1=Wh). Besides, the sum of the channel length L1 of the intrinsic transistor T and the channel length Lh of the correction transistor Th is made to become a predetermined length L (L=L1+Lh). Incidentally, it is desirable to use the device model of the intrinsic transistor T as the device model of the correction transistor Th.

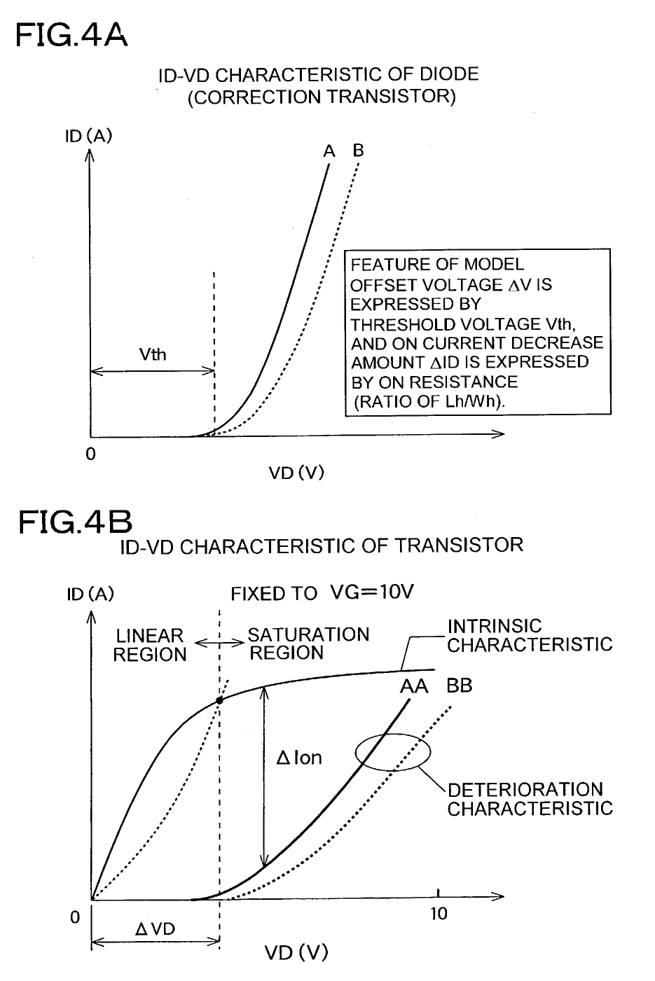

FIGS. 4A and 4B are views showing the correction principle of a diode connection transistor correction model according to this embodiment. FIG. 4A is a graph showing an ID-VD characteristic of a diode-connected transistor (correction transistor), and FIG. 4B is a graph showing an ID-VD characteristic of a corrected thin film transistor (transistor made up of an intrinsic transistor T and a correction transistor Th).

A curved line A and a curved line B shown in FIG. 4A respectively indicate correction characteristics different in threshold voltage Vth (or on current Ion). The curved line B can express a thin film transistor with severer deterioration than the curved line A. As shown in FIG. 4B, a decrease Ion of an on current and an offset voltage ΔVD of the ID-VD curved line are reflected by the diode connection transistor correction model. Hot carrier deterioration (ΔVD and ΔIon) is severer at the ID-VD curved line BB than at the ID-VD curved line AA. The ID-VD characteristic (ID-VD characteristic after deterioration) of a thin film transistor subjected to the hot carrier deterioration can be expressed by adjusting the dimension parameter of the correction transistor Th and the threshold value Vth.

Besides, a degree of deterioration of a transistor is expressed by a ratio Lh/Wh, and Lh is selected within the range of 0 to L (channel length of the intrinsic transistor). When L is large, the deterioration of the transistor is serious. The physical meaning of the channel length Lh of the correction transistor Th is the length of a hot carrier injection region in the L direction. When the deterioration is slight, a trap region of the hot carrier remains in the vicinity of a drain depletion layer, however, when the deterioration is serious, especially in the case of the deterioration due to a high drain voltage, a hot carrier trap region is shifted to the source region side, and the length of the hot carrier trap region is prolonged.

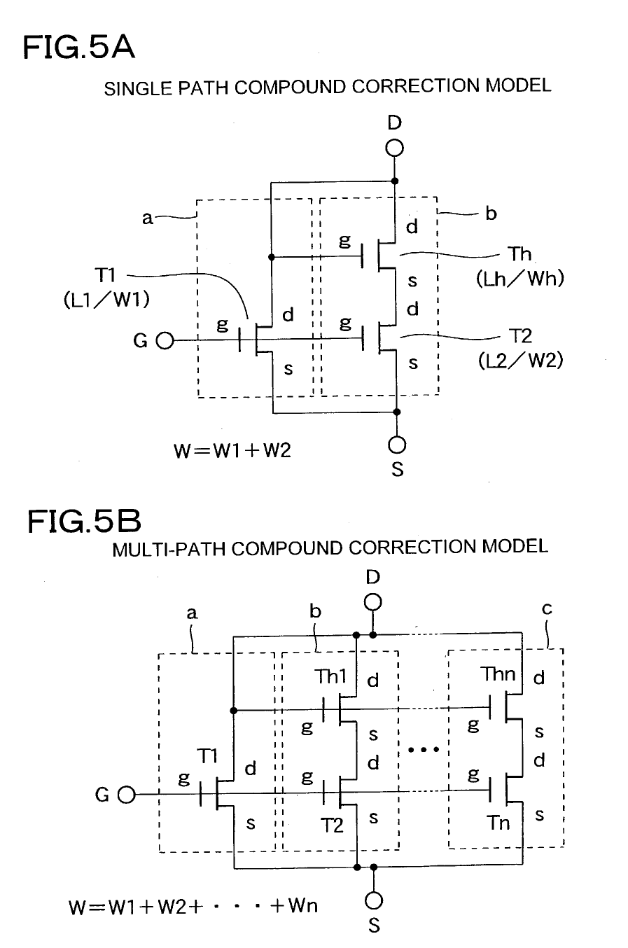

FIGS. 5A and 5B are views showing a compound correction model according to this embodiment. FIG. 5A is a view showing a single path compound correction model, and FIG. 5B is a view showing a multi-path compound correction model. The basic idea of this model is such that one thin film transistor (direction of channel width W) is divided into a portion without deterioration and a portion with deterioration, which are in parallel with each other, the portion without the deterioration is expressed by a conventional transistor model, and the transistor with the deterioration is expressed by the diode connection transistor correction model shown in FIGS. 3A to 4B.

In the case of the single path compound correction model shown in FIG. 5A, a transistor T1 surrounded by a broken line a is an intrinsic transistor without deterioration, and a transistor surrounded by a broken line b is a deteriorated transistor (diode connection transistor correction model). Here, the total channel width W is the total value of the intrinsic transistor and the deteriorated transistor (W=W1+W2).

In the case of the multi-path compound correction model shown in FIG. 5B, a transistor T1 surrounded by a broken line a is an intrinsic transistor without deterioration, and plural transistors surrounded by a broken line b and a broken line c are deteriorated transistors (diode connection transistor correction model). Here, the total channel length W of the transistor is the total value of the intrinsic transistor and the deteriorated transistors. In the case where one transistor to be modeled is divided into one intrinsic transistor and N−1 deteriorated transistors, the total channel width W becomes the total value W=W1+W2+ . . . +Wn of the N transistors.

In the compound correction model shown in FIGS. 5A and 5B, the degree of transistor deterioration is expressed by the ratio of the channel width W occupied by the deteriorated transistors and the Lh/Wh ratios of the respective deteriorated transistors. As described above, Lh is the length of the hot carrier trap region, and when Lh is large, the deterioration degree of the transistor is high.

Next, the reason why the deteriorated transistor is divided into plural parts and the physical meaning of the channel width Wh will be described. In the case of excimer laser crystallization, since crystal grains of a p-Si active layer are distributed at random within the range of 0.1 to 0.5 μm, also in the drain depletion layer, crystal grains of different grain diameter sizes are distributed in the channel width (W) direction. When an electron in the channel passes through the depletion layer, it is accelerated by high electric field and becomes a high energy electron (hot carrier). However, by various scattering mechanisms, the probability that the electron enters into a gate insulating film depends on a grain size, its peripheral grain boundary and interface state, and the density of captured electrons is not uniform in the W direction, and by this, the hot carrier deterioration in the W direction also varies (there can be a region where deterioration does not occur). Accordingly, the deterioration due to the hot carrier injection can be more accurately expressed by dividing the transistor into the intrinsic transistor which is not deteriorated, and the plural deteriorated transistors.

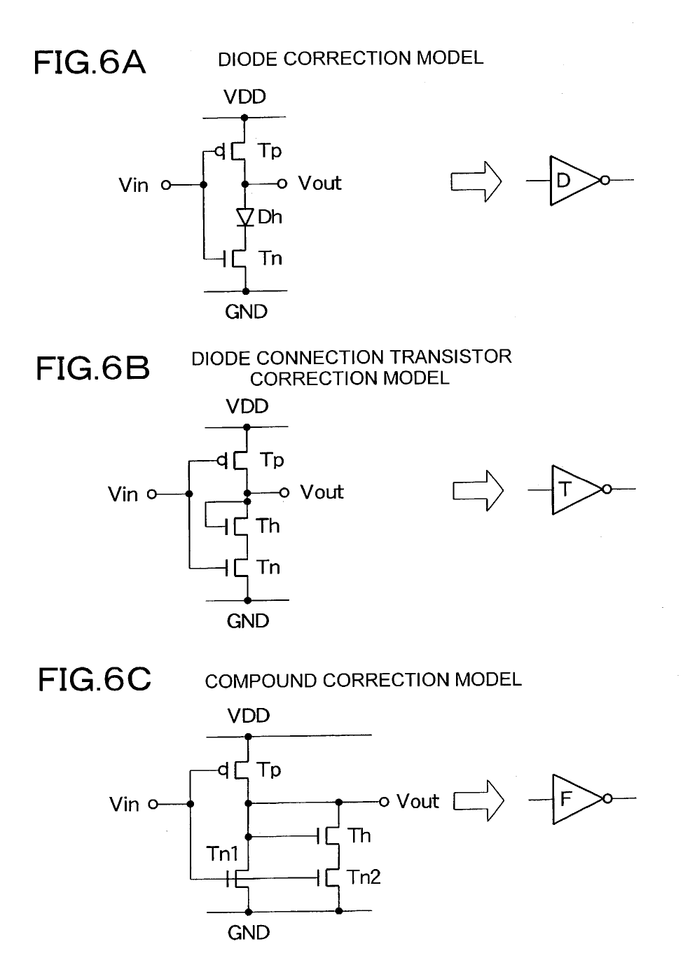

Next, a description will be given of a circuit of the correction model according to this embodiment and application to a system analysis. FIGS. 6A to 6C are equivalent circuit diagrams of CMOS inverters using the device models (correction models) according to this embodiment. FIG. 6A is an equivalent circuit diagram using the diode correction model, FIG. 6B is an equivalent circuit diagram using the diode connection transistor correction model, and FIG. 6C is an equivalent circuit diagram using the compound correction model. Since a p-channel TFT denoted by symbol Tp has no hot carrier deterioration, a conventional model is used, and one of the diode correction model, the diode connection transistor correction model, and the compound correction model is used as a model of an n-channel TFT.

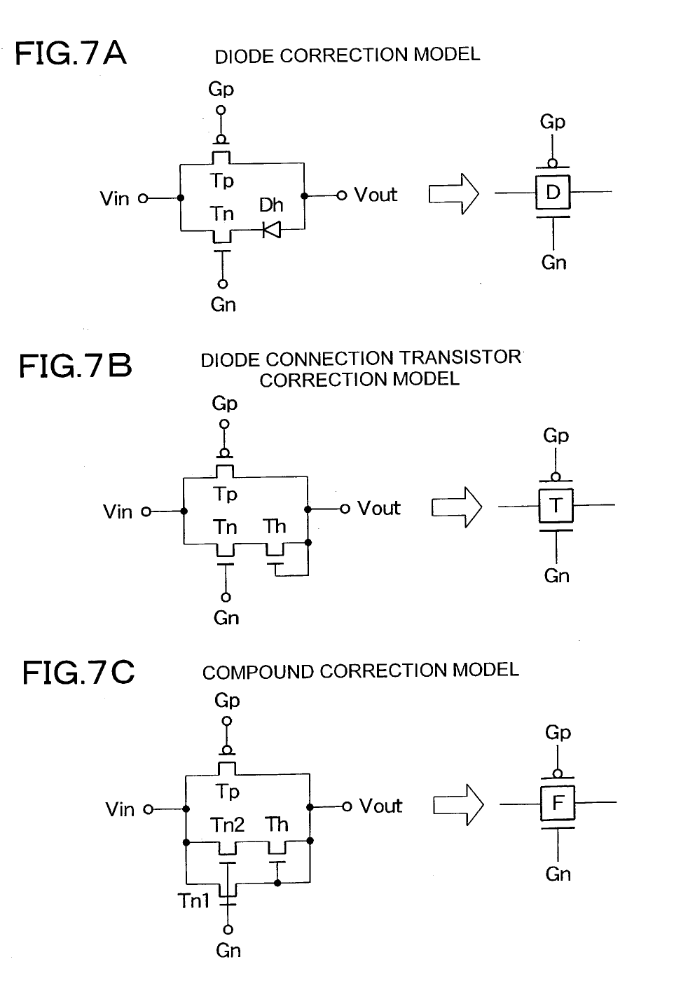

FIGS. 7A to 7C are equivalent circuit diagrams of transfer gates (analog switches) using the device models (correction models) according to this embodiment. FIG. 7A is an equivalent circuit diagram using the diode correction model, FIG. 7B is an equivalent circuit diagram using the diode connection transistor correction model, and FIG. 7C is an equivalent circuit diagram using the compound correction model. Since the p-channel TFT denoted by symbol Tp has no hot carrier deterioration, a conventional model is used, and one of the diode correction model, the diode connection transistor correction model, and the compound correction model is used as a model of an n-channel TFT.

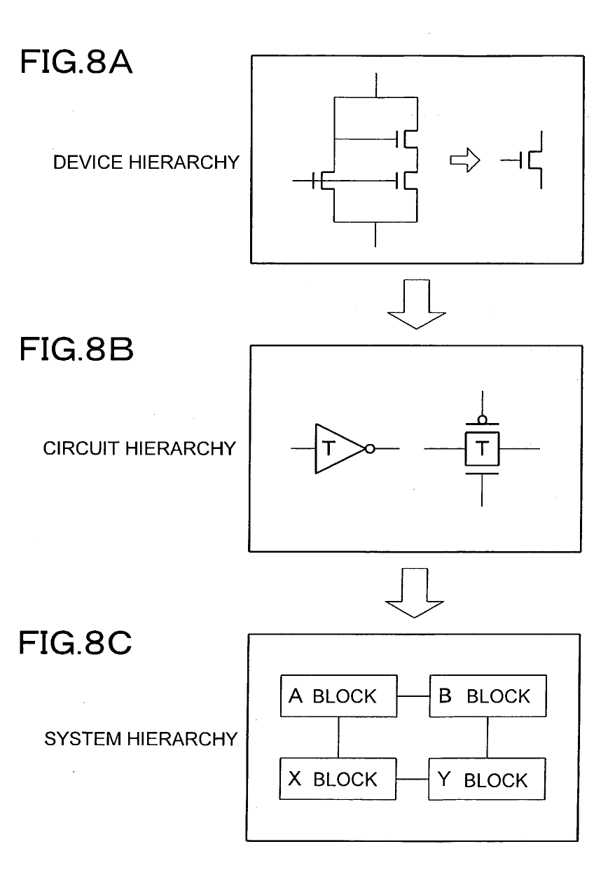

FIGS. 8A to 8C are views for explaining application of this embodiment to a simulation tool. In a device hierarchy, a transistor in which hot carrier injection occurs is expressed by using one of the device models (diode correction model, diode connection transistor correction model, and compound correction model) of this embodiment. In a circuit hierarchy, an electronic circuit is constructed by using a CMOS inverter circuit and a transfer gate using the device model of this embodiment, and various characteristics are simulated and analyzed. In a system hierarchy, a larger function block or electric system is constructed by using plural circuit blocks (for example, A block, B block, X block, and Y block) using the device models of this embodiment, and the characteristics are simulated and analyzed.

As described above, the increase of the nonlinear resistance of the transistor in which the hot carrier injection occurs is simulated by the diode or the thin film transistor in which the gate and the drain are short-circuited, so that the deteriorated transistor can be modeled.

Then, the electronic circuit and system is constructed by the CMOS inverter and the transfer gate using the device model (correction model) according to this embodiment, and the characteristics can be analyzed. Accordingly, the deterioration of the circuit and the system performance due to the transistor deterioration may be grasped. Its example includes logic operation margin, delay characteristics, frequency characteristics, consumed electric power, etc.

Long-term reliability of a circuit and a system can be evaluated and predicted. For example, the performance of an electronic circuit and a system after ten years can be predicted by using a model of a transistor after ten years. Accordingly, a high reliability system made up of thin film transistors can be designed using the correction model of this embodiment.

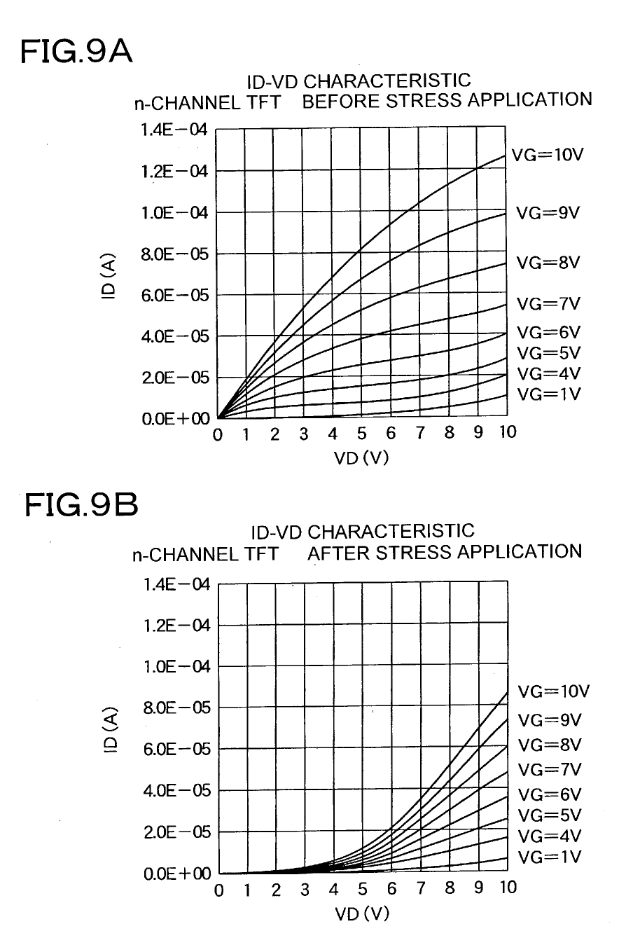

Next, measured data of characteristic change due to the hot carrier will be described with reference to FIGS. 9A to 14B. FIGS. 9A and 9B are graphs showing ID-VD characteristics of an n-channel TFT. FIG. 9A is a graph showing the characteristics before stress application, and FIG. 9B is a graph showing the characteristics after the stress application. Both the graphs show the ID-VD characteristics when a gate voltage VG=1 to 10 V is made a parameter, and a drain voltage VD is changed within the range of 0 V to 10 V at 0.1 V/step. It is understood that an on current is greatly decreased by the stress application, and there appears a ΔVD region (see FIG. 4B) where current does not flow. Incidentally, a DC stress has a stress condition of DC=18 V, VG=2 V, and 10 seconds.

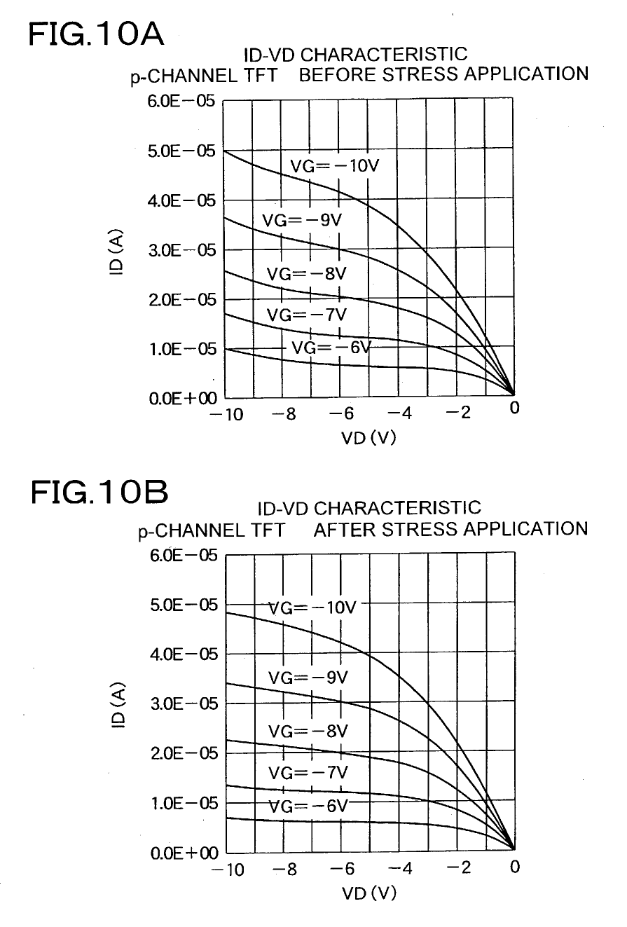

FIGS. 10A and 10B are graphs showing ID-VD characteristics of a p-channel TFT. FIG. 10A is a graph showing the characteristics before stress application, and FIG. 10B is a graph showing the characteristics after the stress application. Both the graphs show the ID-VD characteristics at the time when a gate voltage VG=−10 V to 0 V is made a parameter, and a drain voltage VD is changed within the range of −10 V to 0 V at 0.1 V/step. It is understood that even if the stress under the same condition as the above is applied to the p-channel TFT, the characteristics are not deteriorated.

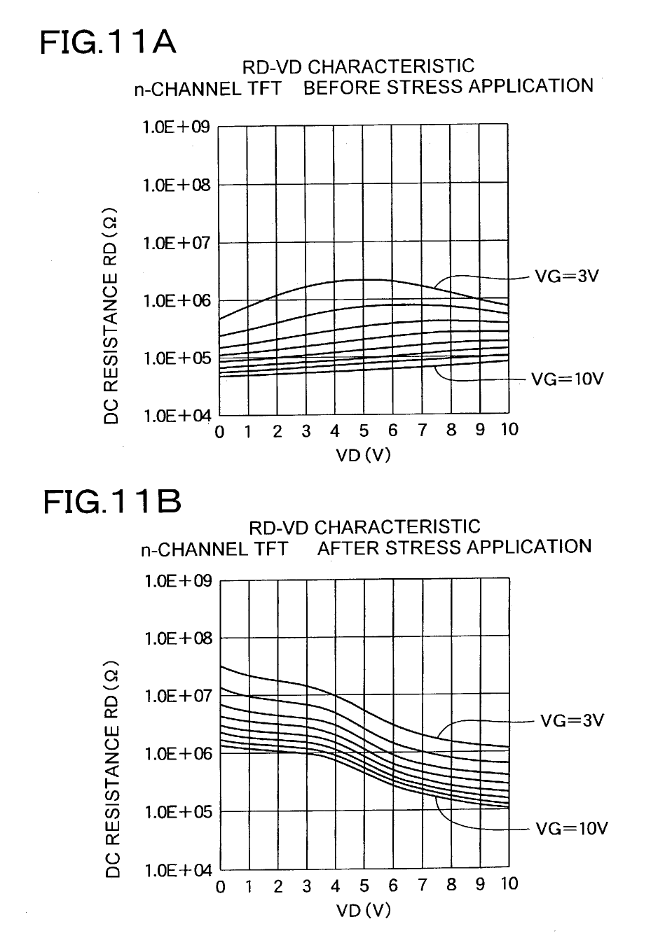

FIGS. 11A and 11B are graphs showing RD-VD characteristics of an n-channel TFT. FIG. 11A is a graph showing the characteristics before stress application, and FIG. 11B is a graph showing the characteristics after the stress application. Both the graphs show the RD-VD characteristics at the time when a gate voltage VG=3 V to 10 V is made a parameter, and a drain voltage VD is changed within the range of 0 V to 10 V at 0.1 V/step. It is understood that by the stress application, the channel resistance RD of the n-channel TFT is greatly increased especially in a linear region where the drain voltage VD is small. The stress condition is the same as the above.

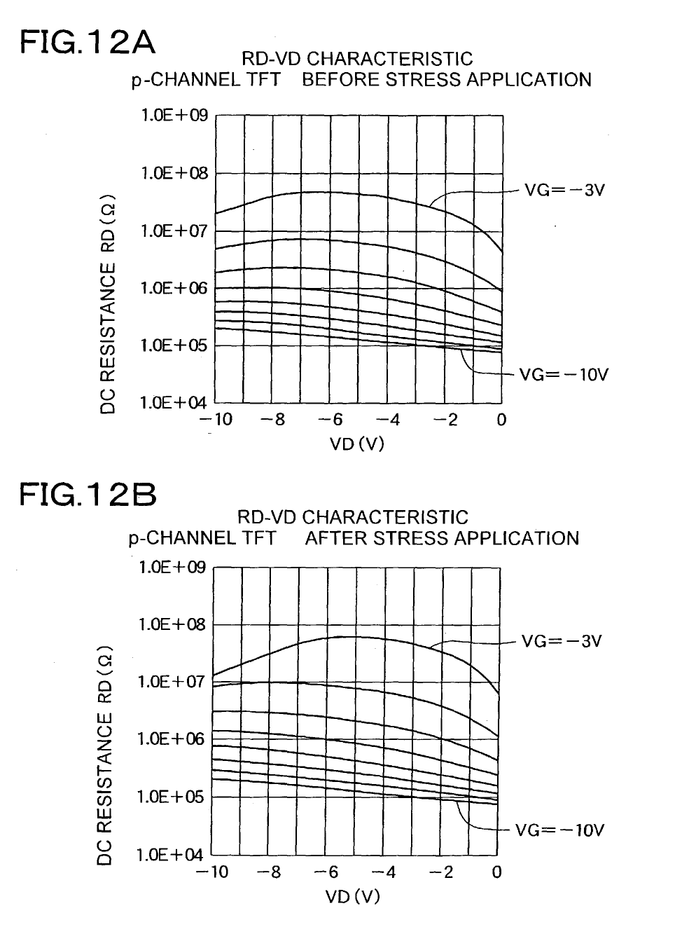

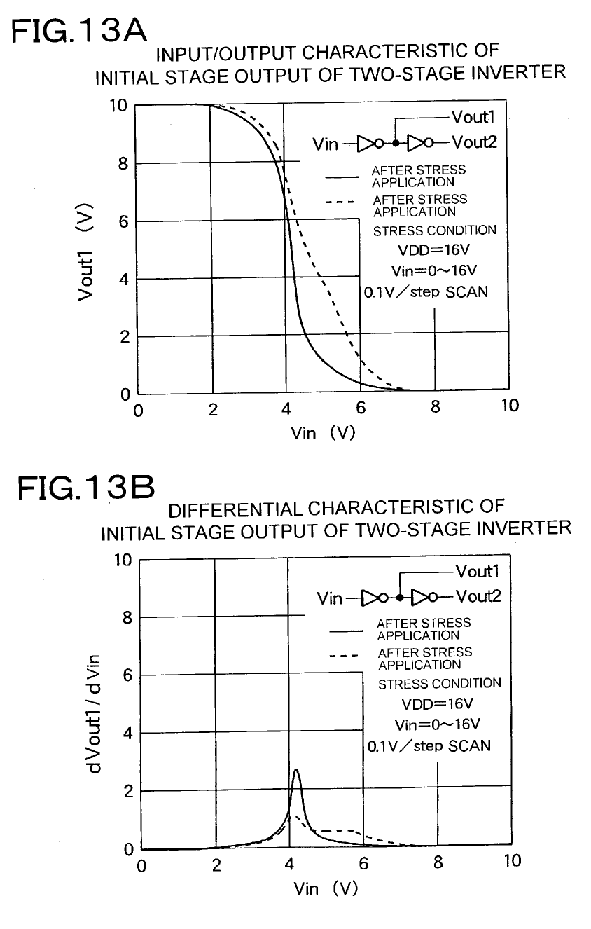

FIGS. 12A and 12B are graphs showing RD-VD characteristics of a p-channel TFT. FIG. 12A is a graph showing the characteristics before stress application, and FIG. 12B is a graph showing the characteristics after the stress application. Both the graphs show the RD-VD characteristics at the time when a gate voltage VG=−3 V to −10 V is made a parameter, and a drain voltage VD is changed within the range of −10 V to 0 V at 0.1 V/step. It is understood that even if the stress under the same condition as the above is applied to the p-channel TFT, the characteristics are hardly changed.

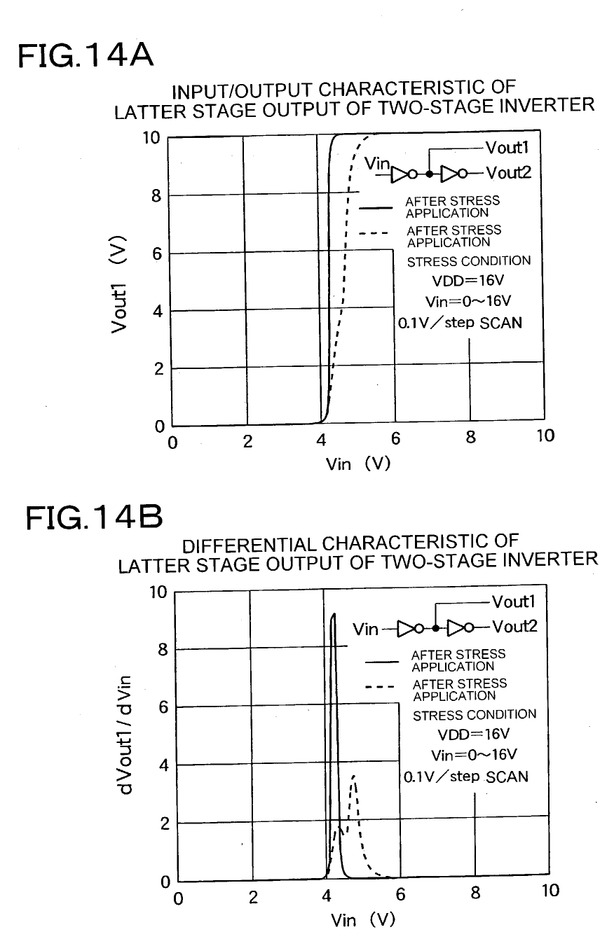

FIGS. 13A and 13B are graphs showing input/output characteristics of an initial stage output of a two-stage inverter and differential characteristics of the initial stage output. FIG. 13A shows the input/output characteristics of the initial stage output, a solid line indicates the characteristic before stress application, and a broken line indicates the characteristic after the stress application. FIG. 13B shows the differential characteristics of the initial stage output, a solid line indicates the characteristic before the stress application, and a broken line indicates the characteristic after the stress application. FIGS. 14A and 14B are graphs showing input/output characteristics of the latter stage output of the two-stage inverter and differential characteristics of the latter stage output. FIG. 14A shows the input/output characteristics of the latter stage output, a solid line indicates the characteristic before the stress application, and a broken line indicates the characteristic after the stress application. FIG. 14B shows the differential characteristics of the latter stage output, a solid line indicates the characteristic before the stress application, and a broken line indicates the characteristic after the stress application.

At the initial stage (first stage), a “trailing edge protuberance” characteristic appears on the side of “LOW” of a trailing edge conversion region of an output voltage Voutl. It is understood that at the latter stage (second stage), “leading edge protuberance” appears on the side of “HIGH” of a leading edge conversion region. The generation of the trailing edge protuberance is due to the increase of direct current resistance RD by hot carrier injection into the n-channel TFT, and the deterioration of the initial stage output characteristic has an influence on the latter stage output. A clear change (shift protuberance) is seen also in the differential characteristic (dVout/dVin) of the output.

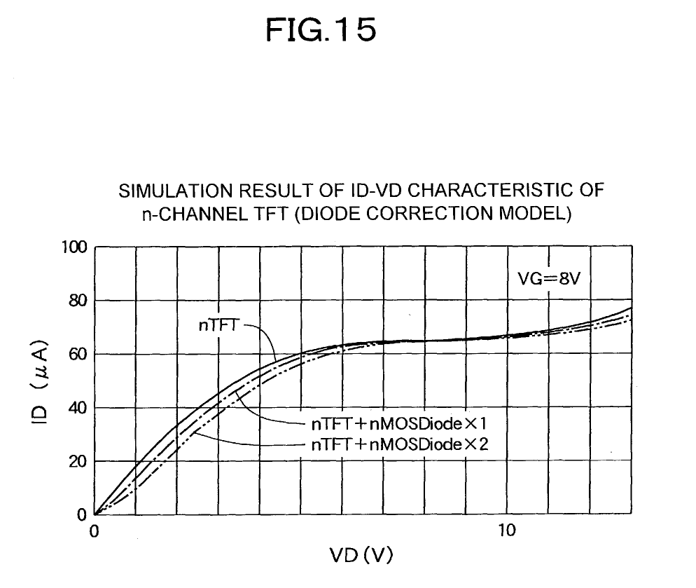

Next, simulation data according to this embodiment will be described with reference to FIGS. 15 to 24. Smart-Spice of SILVACO Inc. was used as a simulation tool, and the Berkeley poly-Si model was used as a model of an intrinsic transistor.

FIG. 15 is a graph showing a simulation result of ID-VD characteristics of an n-channel TFT model to which the diode correction model according to this embodiment is applied. FIG. 15 shows the characteristic (nTFT) of an intrinsic transistor single body (n-channel TFT without hot carrier deterioration), the characteristic (nTFT+nMOS Diode×1) of the diode correction model in which one MOS diode is connected to a drain of the intrinsic transistor, and the characteristic (nTFT+nMOS Diode×2) of the multi-diode correction model in which two MOS diodes are connected in series to a drain of the intrinsic transistor. The n-channel TFT (nTFT) having a channel length of 6 μm and a channel width of 10 μm was used. The MOS diode having a channel length of 0.3 μm and a channel width of 10 μm was used.

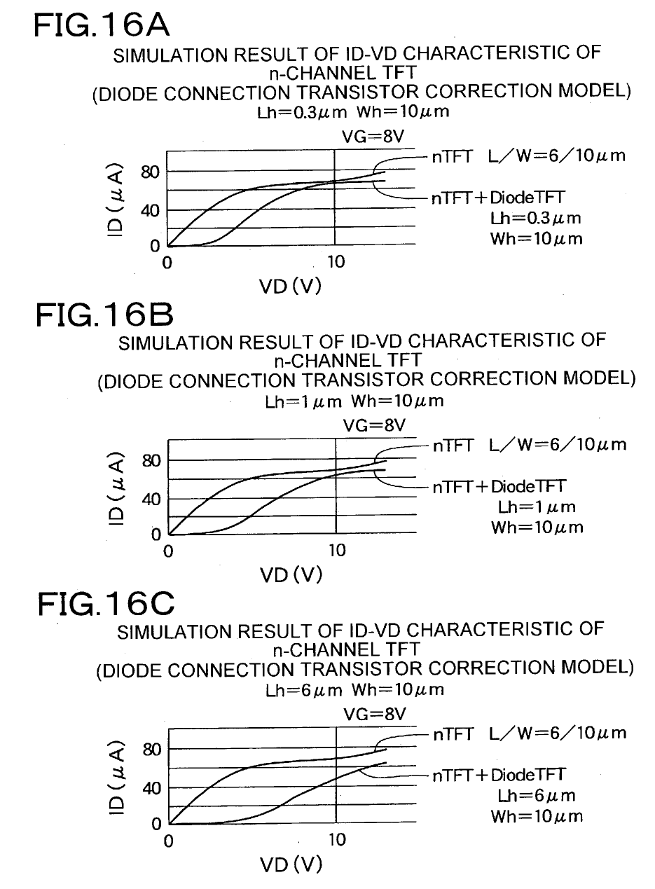

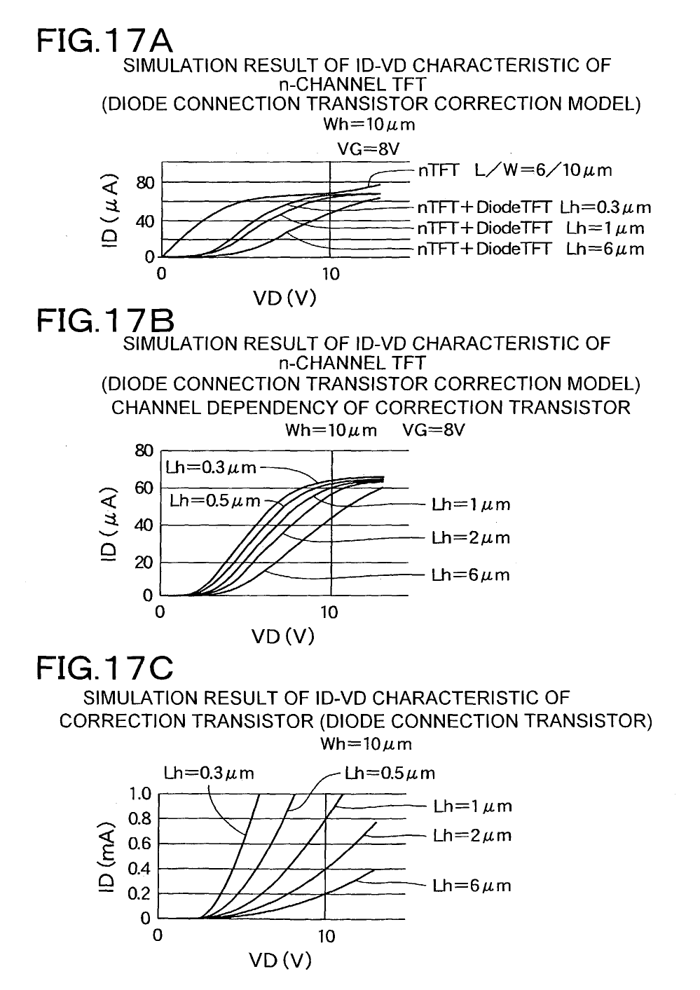

FIGS. 16A to 17C are graphs showing simulation results of ID-VD characteristics of an n-channel TFT model to which the diode connection transistor correction model according to this embodiment is applied. FIG. 16A is a graph showing the simulation result of the case where the channel length Lh of the correction transistor Th is made 0.3 μm, FIG. 16B is a graph showing the simulation result of the case where the channel length Lh of the correction transistor Th is made 1 μm, and FIG. 16C is a graph showing the simulation result of the case where the channel length Lh of the correction transistor Th is made 6 μm. FIG. 17A shows the respective simulation results of FIGS. 16A to 16C in one graph. FIG. 17B is a graph showing the dependence of the ID-VD characteristic on the channel length Lh of the correction transistor Th. FIG. 17C is a graph showing the current-voltage characteristic of the correction transistor Th. It is understood that when the channel length Lh of the correction transistor Th is large, the drain current ID is lowered.

As is apparent from the comparison with the experimental data of FIGS. 9A and 9B, it is understood that the drop of the on current due to the hot carrier injection and the offset voltage ΔVD can be expressed by using this simulation method. Besides, the degree of the hot carrier deterioration can be expressed by changing the channel length Lh.

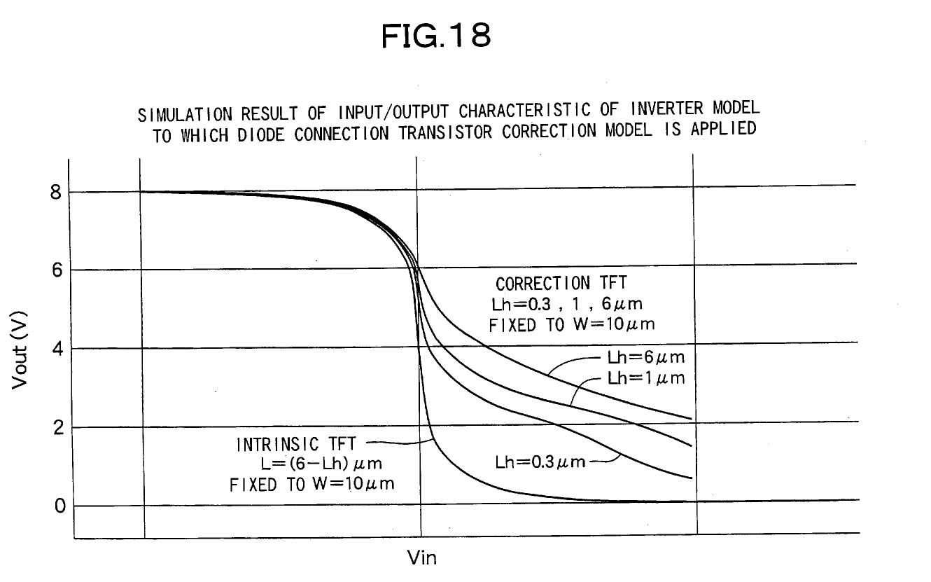

FIG. 18 is a graph showing a simulation result of input/output characteristics of an inverter model to which the diode connection transistor correction model according to this embodiment is applied. FIG. 18 shows the characteristics of the case where the channel length Lh of the correction transistor Th is made 0.3 μm, 1 μm and 6 μm. The channel length L of the intrinsic transistor nTFT is (6−Lh). The channel width of the intrinsic transistor nTFT and the correction transistor Th is 10 μm. From the simulation result shown in FIG. 18, it is understood that when the channel length Lh of the correction transistor Th is large, the protuberance (roundness of trailing waveform) becomes large.

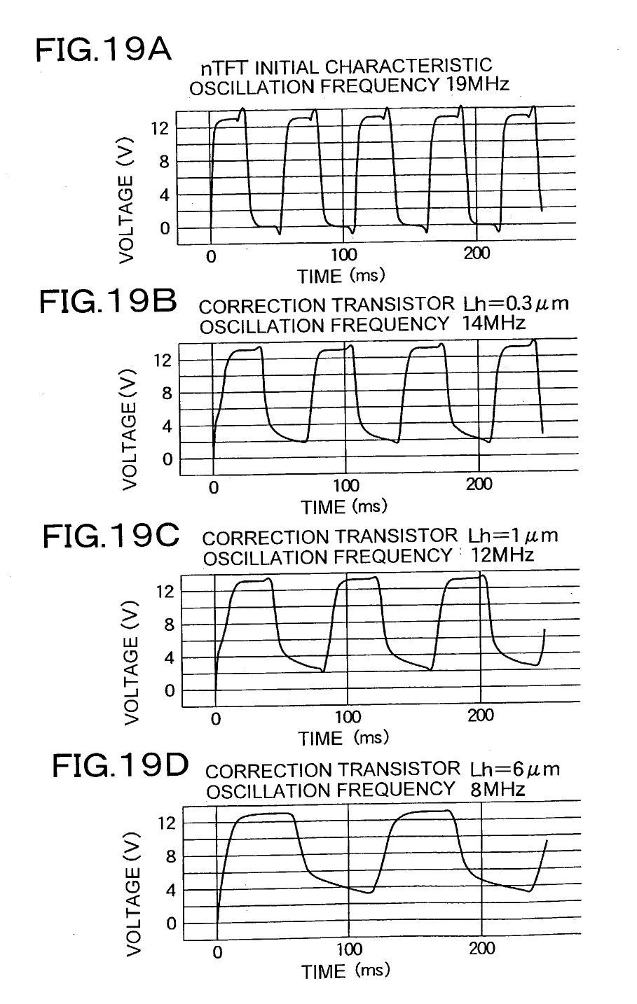

FIGS. 19A to 19D are graphs showing simulation results of an oscillation frequency and oscillation waveform on a ring oscillator (nine-stage inverter structure) constructed by using an inverter model to which the diode connection transistor correction model of this embodiment is applied. FIG. 19A is the simulation result of the case where the intrinsic transistor model without hot carrier deterioration is used, FIG. 19B shows the simulation result of the case where the correction transistor Th having a channel length of 0.3 μm is used, FIG. 19C is the simulation result of the case where the correction transistor Th having a channel length of 1 μm is used, and FIG. 19D is the simulation result of the case where the correction transistor Th having a channel length of 6 μm is used. In the case where the channel length of the correction transistor Th is Lh=0.3, 1 and 6 μm, the oscillation frequency becomes 14 MHz, 12 MHz and 8 MHz, respectively. Besides, it is understood that the LOW level of the oscillation waveform becomes higher than an electric potential of 0 V by the hot carrier deterioration.

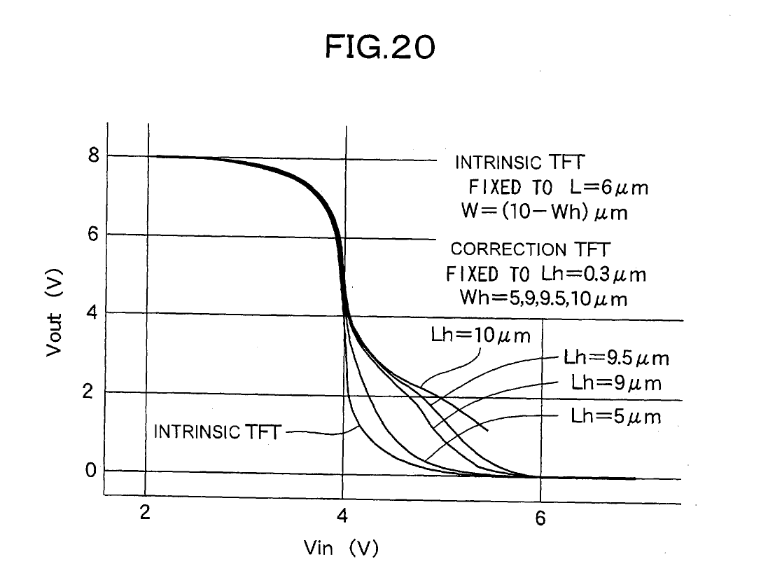

FIG. 20 is a graph showing a simulation result of input/output characteristics of an inverter constructed by using an n-channel TFT to which the compound correction model of this embodiment is applied, and is the graph showing the simulation result in the case where the channel length of the correction transistor is fixed to 0.3 μm, and the channel width is made 5, 9, 9.5 and 10 μm. The channel length Lh of the correction transistor Th is fixed to 0.3 μm, the channel width Wh is changed to 5, 9, 9.5 and 10 μm, and the input/output characteristics of the inverter are simulated. At this time, the channel width W of the intrinsic transistor is changed in conjunction with the width Wh so as to satisfy W=(10−Wh). The larger the channel width W of the deteriorated transistor is, the larger the trailing edge protuberance (roundness of trailing waveform) is.

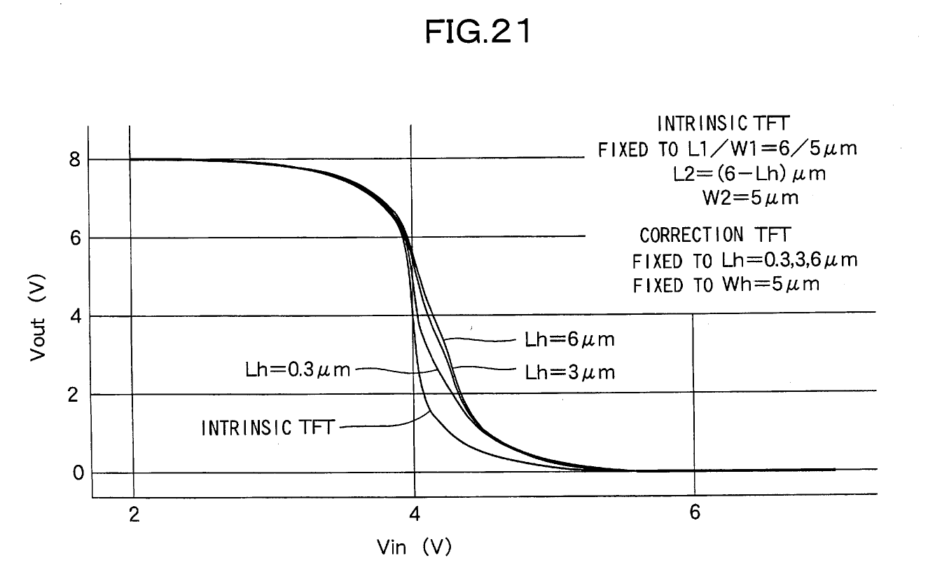

FIG. 21 is a graph showing a simulation result of input/output characteristics of an inverter constructed by using an n-channel TFT to which the compound correction model of this embodiment is applied, and is the graph showing the simulation result of the case where the channel widths W and Wh of intrinsic transistors T1 and T2 and a correction transistor Th are fixed to 5 μm, and the channel lengths L2 and Lh are changed. It is understood that when the channel length Lh of the correction transistor Th becomes large, the trailing edge protuberance (roundness of trailing waveform) is shifted upward.

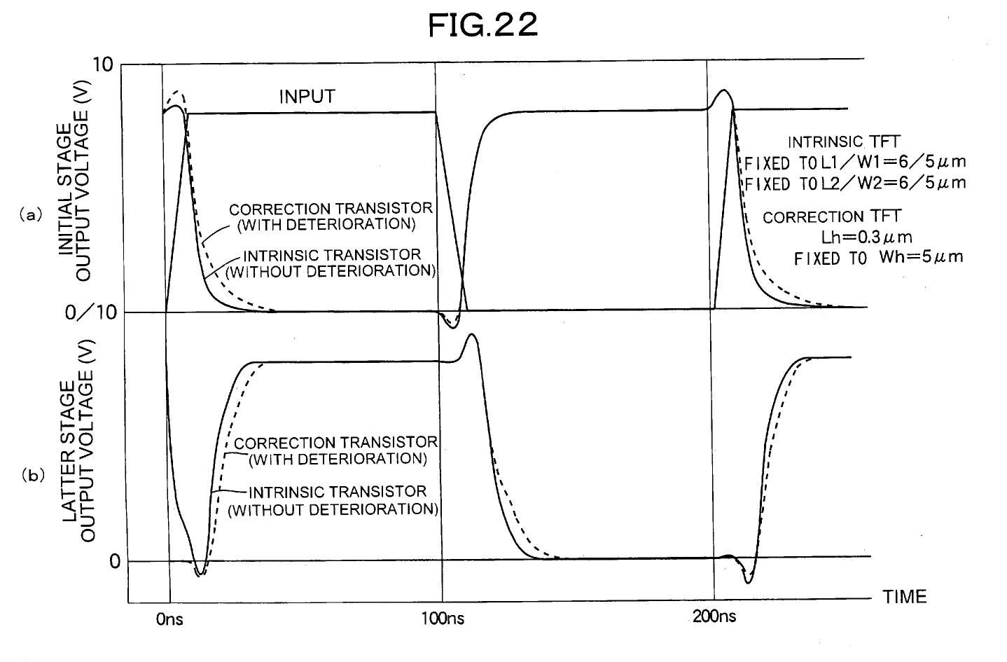

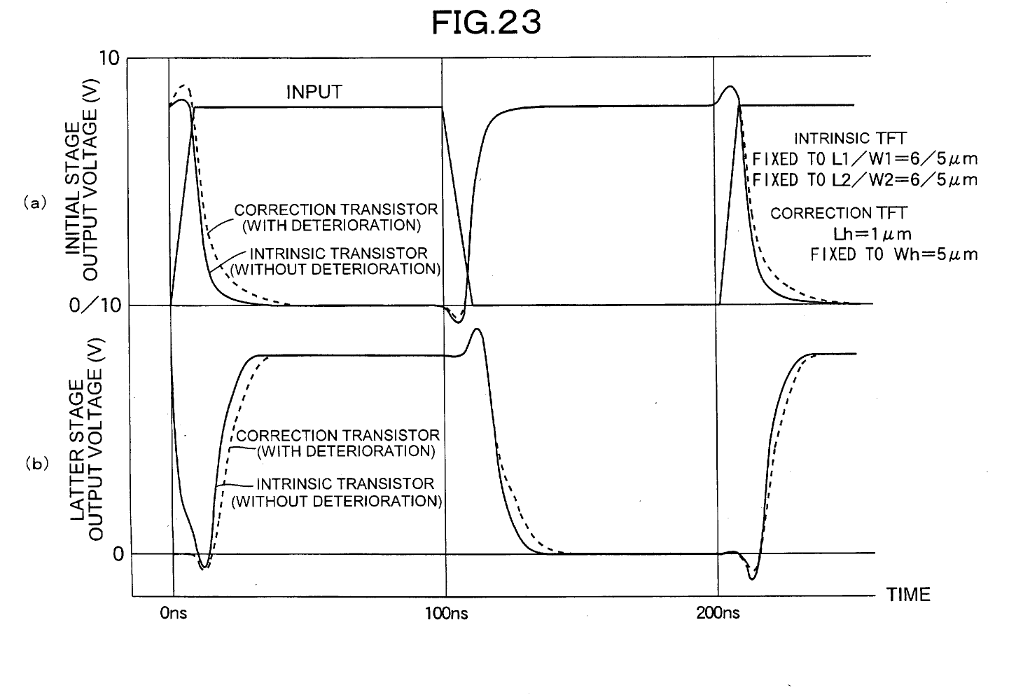

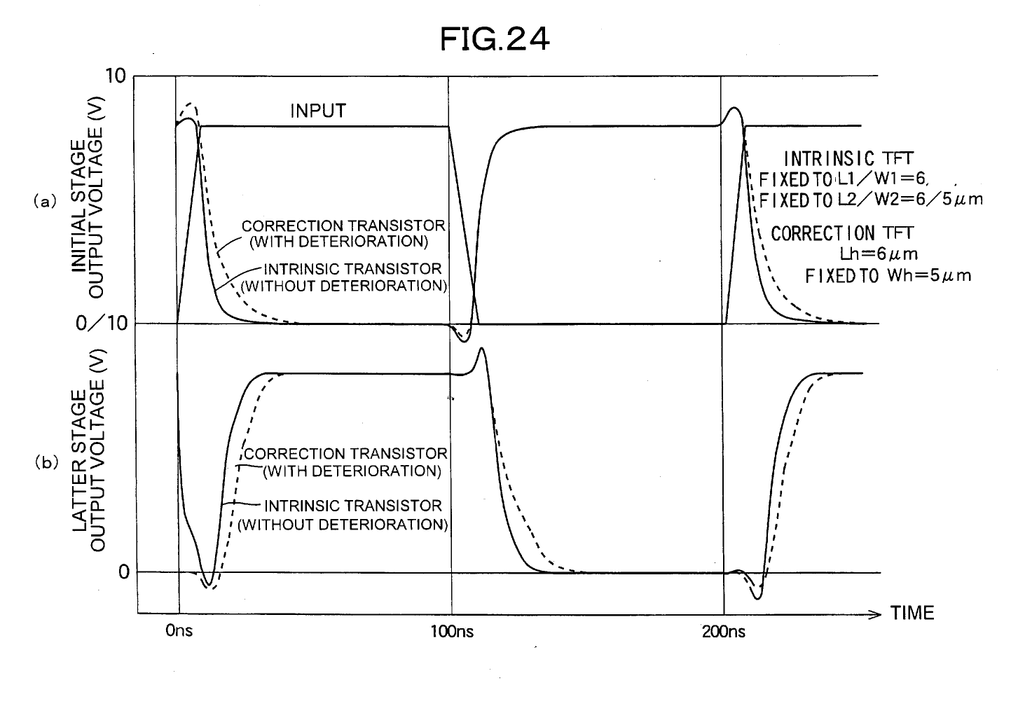

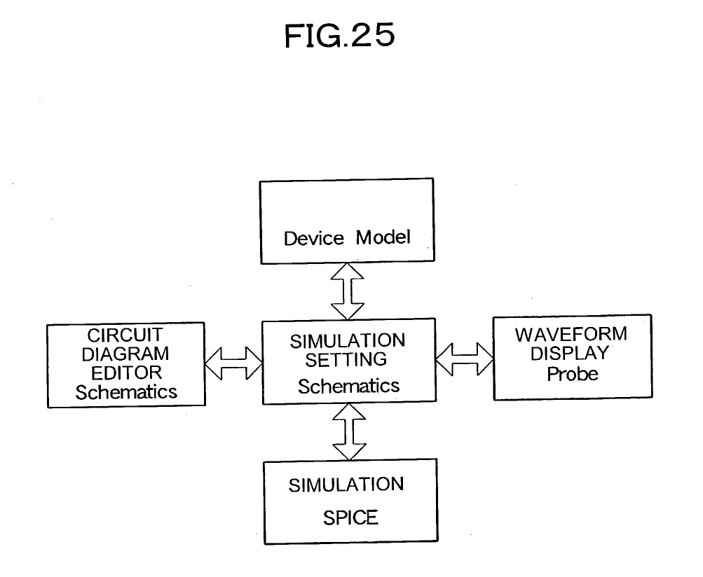

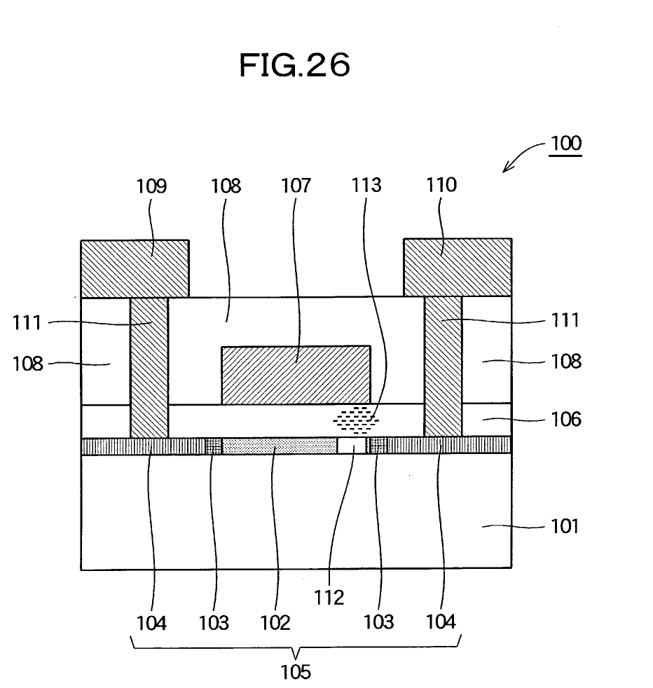

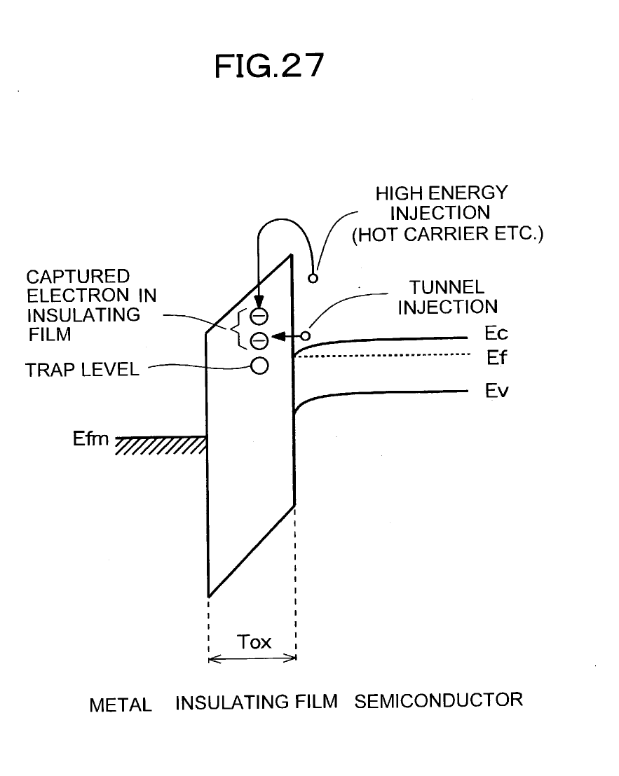

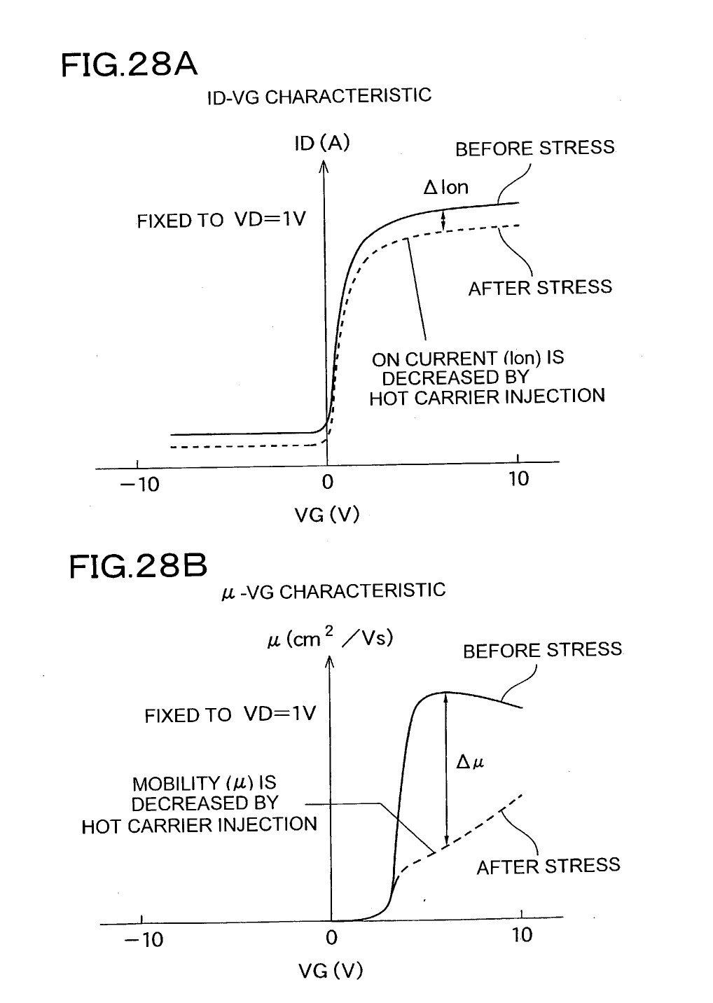

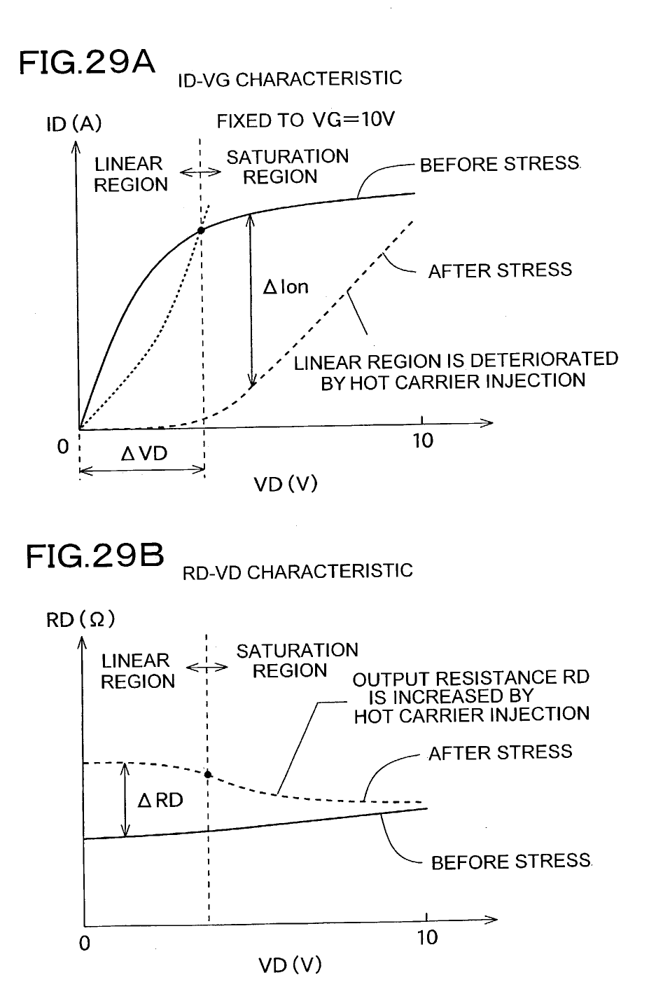

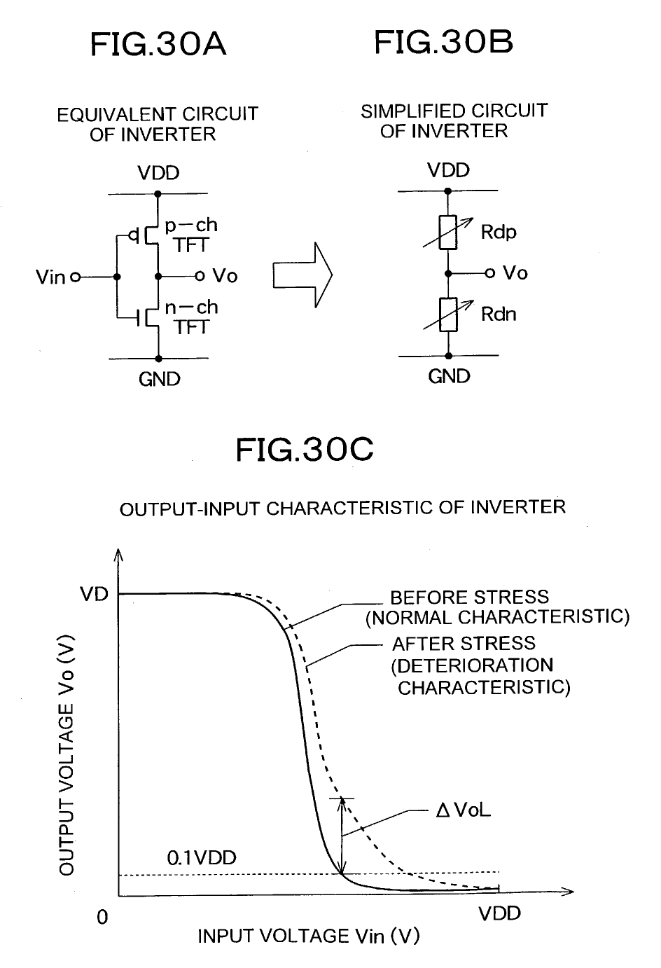

FIGS. 22 to 24 are graphs showing simulation results of AC (alternating current) characteristics of a two-stage cascade connection circuit of inverters constructed by using n-channel TFTs to which the compound correction model of this embodiment is applied. FIG. 22 is a graph showing the simulation result of the case where the channel length Lh of the correction transistor is made 0.3 μm, FIG. 23 is a graph showing the simulation result of the case where the channel length Lh of the correction transistor is made 1 μm, and FIG. 24 is a graph showing the simulation result of the case where the channel length Lh of the correction transistor is made 6 μm. FIG. 22(a), FIG. 23(a) and FIG. 24(a) show input waveforms and output waveforms from an initial inverter, and FIG. 22(b), FIG. 23(b) and FIG. 24(b) show output waveforms from a latter inverter.

When the on characteristic of the n-channel TFT constituting the inverter is deteriorated (drop of the on current, drop of the mobility, increase of the on resistance, etc.) by the hot carrier deterioration, and the drive capability of the inverter is lowered, a discharge time to a load (here, the inverter of the latter stage) is increased. The rising characteristic of the output voltage of the inverter is determined by the drive capability of a p-channel TFT. Here, since it is assumed that the characteristics of the p-channel TFT are not changed, the rising characteristic of the initial stage inverter output is not deteriorated. However, since an output signal of the initial inverter becomes an input signal of the latter inverter, the fall delay of the initial stage inverter output results in the delay of a rising characteristic of the latter stage inverter output. In this meaning, in the case of an electronic circuit constituted by a multi-stage inverter, a delay due to the hot carrier deterioration occurs in both the rising characteristic and falling characteristic.

As described above, according to this invention, a nonlinear resistance including two terminals or: three terminals and having drain voltage dependence is connected in series to a drain electrode of a device model of an intrinsic thin film transistor without hot carrier deterioration, and an increase of nonlinear resistance due to hot carrier injection is simulated, so that the thin film transistor may be modeled more accurately. Thus, the analysis accuracy of electronic circuit simulation may be raised, and a characteristic change with the passage of time, reliability and lifetime may be estimated and predicted.

What is claimed is:

1. A simulation method, comprising the steps of:
constructing a device model of a thin film transistor, which is formed on an insulating substrate, from an intrinsic transistor without hot carrier deterioration and a nonlinear resistance element connected in series to a drain electrode of the intrinsic transistor; and
performing a circuit simulation using the device model of the thin film transistor.

2. A simulation method according to claim 1, wherein the nonlinear resistance element is a diode.

3. A simulation method according to claim 1, wherein the nonlinear resistance element is a transistor in which a gate electrode and a drain electrode are short-circuited.

4. A simulation method according to claim 1, wherein the nonlinear resistance element is a thin film transistor in which a gate electrode and a drain electrode are short-circuited, and an increase of a channel resistance due to hot carrier deterioration is set by setting a channel length, a channel width, and a threshold value of the thin film transistor to predetermined values, respectively.

5. A simulation method, comprising the steps of:
constructing a device model of a thin film transistor, which is formed on an insulating substrate, from an intrinsic transistor without hot carrier deterioration, and a transistor connected in parallel to a source electrode and a drain electrode of the intrinsic transistor and having hot carrier deterioration; and
performing a circuit simulation using said device model of the thin film transistor.

6. A simulation method according to claim 5, wherein the transistor having the hot carrier deterioration is divided into plural parts.

7. A simulator comprising:
a device model of a thin film transistor formed on an insulating substrate, wherein
the device model includes an intrinsic transistor without hot carrier deterioration and a nonlinear resistance element connected in series to a drain electrode of the intrinsic transistor, or includes an intrinsic transistor without hot carrier deterioration and a transistor connected in parallel to a source electrode and a drain electrode of the intrinsic transistor and having hot carrier deterioration, and
a circuit simulation is performed using the device model of the thin film transistor.
